(19) United States
(12) Patent Application Publication
(10) Pub. No.: US 2026/0211459 A1
(43) Pub. Date: Jul. 23, 2026

(54) PLANAR ELECTRONIC DEVICE WITH SCREEN

(71) Applicant: Grant SINCLAIR, Cardiff (GB)

(72) Inventor: Grant SINCLAIR, Cardiff (GB)

(21) Appl. No.: 19/139,808

(22) PCT Filed: Dec. 18, 2023
(86) PCT No.: PCT/GB2023/053288

§ 371 Date: Jun. 16, 2025

(30) Foreign Application Priority Data
Dec. 16, 2022 (GB) 2219107.6

(51) Int. Cl. G06F 1/16

(52) U.S. Cl. CPC G06F 1/1658; G06F 1/1626; G06F 1/1671

(57) ABSTRACT

A planar electronic device comprises a casing with a front surface, with an electronic display screen thereon, and an opposite back surface, a maximum thickness between the front surface and the opposite back surface of less than 1 cm, a power storage module, a processor and at least one user input device, the planar electronic device having a top portion with an aperture for receiving at least one prong therethrough.

### FIELD OF THE INVENTION

The invention relates to the field of planar hand-held electronic devices with screens.

### BACKGROUND TO THE INVENTION

Planar hand-held electronic devices with screens, such as computers, gaming consoles, mobile phones, cameras, music synthesizers, puzzles, monitoring devices etc. are in common use. Nevertheless, even basic devices have a significant cost, due in part to the cost of components but also due to the cost of manufacture, housing the components, and packaging and distributing the products.

It would be advantageous to provide a hand-held electronic device with a screen which is cost effective to manufacture and distribute while still being formed sufficiently robustly to resist wear and have a useful lifetime.

GB2591840A entitled “Electronic devices comprising printed circuit boards” discloses an electronic device having a stack of PCBs.

It is in this context that the present invention has been made. Some embodiments also address the issue of providing a device which can be readily recycled.

### SUMMARY OF THE INVENTION

According to a first aspect of the invention there is provided a planar electronic device. It may be that the device comprises a casing with a front surface and an opposite back surface. It may be that the casing has a maximum thickness between the front surface and the opposite back surface of less than 1 cm. It may be that the device comprises a power storage module. It may be that the device comprises a processor. It may be that the device comprises at least one user input device. Typically the front surface has an electronic display screen thereon.

It may be that the at least one user input device comprises one or more buttons corresponding to piano keys. It maybe that the one or more buttons corresponding to piano keys are aligned along a side edge of the device.

The thickness of the electronic device may vary along the length of the electronic device. For example, the minimum thickness of the electronic device may be typically at least 1 mm, typically at least 2 mm, typically at least 3 mm, or typically at least 4 mm. The thickness of the electronic device may vary by typically at least 1 mm, typically at least 2 mm, or typically at least 3 mm.

Typically, the planar electronic device has a top portion with an aperture for receiving at least one prong therethrough. The aperture for receiving the at least one prong may be a single aperture in a regular (e.g. a circle) or irregular shape (e.g. a kidney shape).

Typically, the aperture is a looped hook receiving aperture.

Accordingly, the planar electronic device may hang from a looped hook by the aperture. The device may therefore be conveniently displayed on point of sale display stands which use looped hooks and distributed along with other planar products (such as gift cards etc.) designed to hang from looped hooks on display stands.

The position of the aperture (i.e. the aperture for receiving the at least one prong) thereby defines which end is the top of the device. The top end (where the top portion is located) will be uppermost when the planar device is hung from a prong (e.g. a looped hook). The opposite end is referred to herein as the bottom. The sides (left and right) are the edges of the front and back surfaces of the case which extend upwards and downwards at the side of the device as viewed when hanging from the aperture. Typically, the screen is below the aperture.

Typically, the aperture is in the form of a slot having a width of 32±4 mm.

It may be that the aperture has a height of 6 to 8 mm. The aperture may comprise an indentation, or spaced apart indentations, to receive hook bars having a diameter of 6.5±1 mm. Accordingly, the planar device is compatible with standard Eurohook point of sale displays.

Nevertheless, in some embodiments, the electronic device could be made with an aperture through a protrusion (e.g. tag) mounted to the top of the electronic device instead of through the casing (and typically also the PCB).

The planar device may have a width of 50-120 mm, typically 75-95 mm. The planar device may have a height of 100-150 mm, typically 120-130 mm. The planar device may have a thickness of less than 1 cm. The planar device may have a thickness of less than 0.75 cm. The planar device may have a thickness of less than 0.5 cm.

It may be that the planar device has a weight of (equal to or) less than 150 g, (equal to or) less than 100 g, (equal to or) less than 75 g or (equal to or) less than 50 g. In one example, it may be that the planar device has a weight of 75 g.

The casing is typically cuboidal.

Typically, the casing is formed from a creased sheet. In other examples, the casing may be formed from a plurality of layers stacked on one another, as will be discussed below.

The creased sheet may be folded. Constructing the electronic device may comprise folding a sheet to form the creased sheet. Construction may include the step of forming one or more creases. Typically, the creased sheet is flexible. The creased sheet may be formed with creases, for example from a resilient plastics material.

The creased sheet typically comprises the aperture (i.e. the aperture for receiving the at least one prong). The PCB may also comprise an aperture (i.e. the aperture for receiving the at least one prong). Thus, a prong (e.g. looped hook) may extend through the casing and the PCB in use. The aperture of the PCB may correspond with and/or be aligned with the aperture of the casing. This provides additional strength and/or facilitates use of the area on either side of the aperture for electronic components attached to the PCB, contributing to the compact overall configuration.

The creased sheet may comprise a back portion containing an aperture (i.e. an aperture for receiving the at least one prong) and a flap containing a corresponding aperture (i.e. the aperture for receiving the at least one prong) which is folded over the top of the PCB in use such that the apertures align. Typically a spacer is provided around the aperture.

The creased sheet may comprise one or more flap portions, which typically wrap around the PCB to form the casing. The one or more flap portions may be secured with adhesive.

It may be that the casing is formed from cardboard. Thus, the creased sheet may be a creased sheet of cardboard.

The casing may comprise one or more sheets of cardboard. The cardboard may have a protective layer thereon. It may be that the planar device has a casing formed from a folded cardboard sheet. The use of cardboard reduces the environmental impact of the product and facilitates recycling, while enabling a thin product to be obtained. It would be difficult to achieve the same thickness with injection moulding without a complex and therefore expensive moulding process.

The cardboard casing may be multilaminate. The cardboard casing may comprise one or more coatings. For example, the cardboard casing may comprise a waterproofing coating, and/or a colouring coating.

It may be the that cardboard casing is texturized or coated in a texturized material. For example, the cardboard casing may comprise a plastic like (e.g. “soft touch”) coating or layer. The cardboard casing may comprise a sulphite and acid-free paper, such as plike (Plike is a registered trade mark). Advantageously, a planar electronic device with a “soft touch” feel has improved grip and is recyclable. Cardboard is light which reduces transport (e.g. postage) costs.

It may be that the casing comprises a sheet which is more than double the width of the planar device, folded around a printed circuit board.

The planar device typically comprises a PCB with the display screen and a plurality of electronic components mounted thereto. The PCB may comprise a plurality of reinforcing metal regions configured to reduce the flexibility of the PCB. This additional reinforcement facilitates the use of a flexible sheet material, such as cardboard, for the casing and is preferable to using a metal chassis or similar.

Typically the power storage module is a battery. Typically, the power storage module is fitted in a cavity formed by an aperture in the PCB. It may be that the power storage module extends through the entire thickness of the PCB such that it is exposed on both the front and rear surfaces of the PCB.

It may be that the device comprises a PCB which has a thickness of less than 1 mm. It may be that the PCB has a plurality of reinforcing metal regions thereon configured to reduce the flexibility of the PCB. It may be that the aperture for receiving the at least one prong is formed by overlapping apertures in the PCB and the casing. This enables the device to be thinner than would otherwise be possible, particularly where the casing is flexible (e.g. cardboard). Some or all of the reinforcing metal regions may be reinforcing metal regions. Some or all of the reinforcing metal regions may comprise metal regions filled in between signal conducting regions.

At least some of the reinforcing metal regions may extend across the majority of the width of the device. At least some of the reinforcing metal regions may extend across the majority of the length of the device. Some or all of the reinforcing metal regions may not conduct signals. They may be electrically isolated although they may usefully be used as a ground plane, for example. Some or all of the reinforcing metal regions may be wider than 1 mm. Some or all of the reinforcing metal regions may be thicker than the signal conductors on the PCB. Pairs of parallel reinforcing metal regions may be formed opposite each other on the front and back surface of the PCB to thereby reduce flexibility.

Typically, the reinforcing metal regions on the PCB have a thickness of at least 10 microns. It may be that the reinforcing metal regions on the PCB have a thickness of typically at least 20 microns, typically at least 30 microns, typically at least 35 microns, typically at least 50 microns, typically at least 60 microns or typically at least 70 microns. It may be that the reinforcing metal regions on the PCB have a thickness of typically at least 1 oz or typically at least 2 oz. It may be that metal regions are formed on a rear surface of the PCB. Advantageously, the metal regions strengthen the electronic device by adding supportive structure to the PCB.

Typically, at least 25% of at least one surface of the PCB is metalized. It may be that the metallization is copper or gold. Typically, at least 25%, typically at least 50%, or typically at least 75% of the at least one surface of the PCB is metalized. It may be that the surface is the front surface of the PCB, i.e. the surface of the PCB comprising the display, and/or the back surface of the PCB, i.e. the surface of the PCB opposite to the surface of the PCB comprising the display. Advantageously, the metallization strengthens the electronic device by adding supportive structure to the PCB.

Typically, the casing has a display aperture therein and the electronic display screen is visible through the display aperture.

The electronic display screen may be part of an electronic display unit which is adhered to the casing, typically using tape, with a viewing region of the electronic display screen visible through the display aperture.

The electronic display screen may for example be LCD, TFT, OLED or ePAPER. It may be that the electronic display screen is an LED array. The LED array may be a high-power COB LED array. The LED array may be an integrated programmable RGB LED.

It may be that the electronic device comprises an LED array. The LED array may be a high-power COB LED array. The LED array may be an integrated programmable RGB LED.

It may be that the electronic display screen is part of an electronic display unit, the electronic display unit being typically rectangular and having a viewable region with an electronic driver circuitry along a side thereof. Typically, the display aperture is rectangular. Typically, the centre of the display aperture is offset (i.e. to the side) from the longitudinal axis of the casing.

Thus, the viewable region of the electronic display unit may be visible through the offset display aperture while enabling the electronic display unit to be conveniently packaged within the casing.

It may be that the creased sheet (optionally cardboard) forms the majority of the front face of the planar device and also has one or more user actuatable button formations mounted thereon.

The one or more button formations may be formed as part of the creased sheet, for example, they may be embossed. The one or more button formations may be attached (e.g. adhered) to the creased sheet. This provides a simple and cost effective way to form a casing and one or more buttons thereon in a compact device.

One or more cavities may be defined within the casing.

The planar electronic device may comprise one or more spacers within the casing. Typically, the one or more spacers define one or more cavities which retain one or more electronic circuit components.

It may be that one or more spacers extend widthwise across the casing. It may be that one or more spacers extend between the front portion of the casing and the PCB. It may be that the one or more spacers further comprise one or more apertures. Thus the casing, the one or more spacers and their one or more apertures, and typically also the PCB may thereby define one or more said cavities.

The one or more electronic circuit components may for example comprise a processor, a memory, a system on a chip device comprising a processor and memory, a microphone, a loudspeaker, an interface circuit, a power supply circuit, a wireless communications transceiver circuit, an electrical connector (e.g. a USB connector). It may be that electronic circuit comprises a System on Module (SOM) chip, which typically is soldered to the PCB.

The one or more spacers may be used to maintain the shape of the flexible creased (e.g. folded) casing and to protect components within the casing. This facilitates the use of cardboard or a sheet of another flexible material for the casing and avoids a requirement for structures such as a metal chassis. It may be that the casing (e.g. creased sheet) is in contact with the one or more spacers. It may be that the one or more spacers are also in contact with the PCB. Thus one or more spacers may extend from the PCB to the casing.

The one or more spacers may be made of cardboard, for example formed from a plurality of layers of cardboard. This simplifies recycling of the product.

It may be that there is at least one said cavity retaining one or more electronic circuit components located on the left side, and/or the right side, of the aperture for receiving the at least one prong.

This configuration makes good use of the space located on either side of the aperture (i.e. the aperture for receiving the at least one prong), enabling a compact device to be made.

The planar electronic device may comprise at least one spacer which comprises at least one fixed portion and at least one actuator portion which defines one or more button actuators.

The fixed portion of the spacer will typically define one or more said cavities. One or more said cavities may be defined between at least one fixed portion and at least one actuator portion.

The button actuators may comprise spacer portions which extend from the casing to electrical contacts on the PCB such as to open or close one or more electrical contacts when pressed by a user. Thus it may be that, in use, a user presses the external casing which flexes and force is transferred through the spacer portions to open or close one or more electrical contacts on the PCB. The casing typically comprises one or more user actuatable button formations, each of which overlays a button actuator such that the respective button actuator is moved to open or close one or more electrical contacts when the respective user actuatable button formation is pressed.

It may be that the button actuators are dome switches or snap domes. The dome switches or snap domes may be fixed to the PCB using adhesive, such as tape or glue. However, it may be that the button actuators are pre-soldered to the PCB.

In some embodiments, it may be that the user actuatable button formations directly contact the electrical contacts on the PCB when the user presses the respective user actuatable button formation. It may be that the user actuatable button formations comprise conductive contact regions (e.g. conductive carbon contacts pills). It may be that the conductive contact regions are attached via adhesive.

It may be that the button actuators comprise at least one, and typically at least two, clusters of buttons, with at least one cavity located adjacent a corner of a cluster of buttons.

It may be that a cavity is located between two clusters of buttons, above or below the clusters.

The one or more buttons may for example comprise round buttons, rectangular piano keys, rectangular (e.g. square) keyboard buttons etc.

It may be that the one or more button actuators are connected to each other by flexible spacer portions, with gaps therearound.

It may be that one or more button actuators are connected to each other by branched flexible spacer portions and connected to at least one fixed portion of the spacer by a single branched spacer portion. The at least one fixed portion of the spacer may be an outer portion of the spacer defining the periphery of the spacer.

It may be that a power on button is located within a said cavity. The power on button may be located within a said cavity located adjacent a corner of a cluster of buttons, for example between two clusters of buttons. Thus actuation of the power on button requires the casing to be pushed or squeezed significantly. This avoids accidental power on of the device while it is being transported or displayed on a loop hook display. A protrusion may extend forward from the front surface of the casing partially or wholly around the power on button, to reduce the chance of accidental actuation of the power on button. The power on button may optionally function as a power off button.

It may be that the planar electronic device comprises one or more clusters of buttons on the front surface and one or more buttons on the rear surface, typically wherein one or more buttons on the rear surface are located opposite an interstice between a cluster of buttons on the front surface.

This reduces the chance of a user accidentally actuating a rear button when they intend to actuate a front button, or via versa, while maintaining a low profile.

It may be that the planar electronic device comprises, in order from top to bottom along a longitudinal axis of the device, the top portion which comprises the flexible spacer portion, a display region which comprises the display screen, a power storage module region which comprises a power storage module and a user interface region which comprises one or more buttons.

This configuration makes good use of the space within the casing while enabling the device to hang from a looped hook, and to have the buttons ergonomically located close to bottom of the device while separated from the screen. This configuration is relatively easy to use.

The power storage module may extend widthwise across the device.

In some examples, the planar device may comprise an alternative power storage module to a battery. For example, a different type of energy storage device may be used, such as a super capacitor.

As mentioned above, the casing may be formed from a plurality of layers stacked on one another. It may be that the device comprises a first layer forming the front surface of the casing. It may be that the device comprises a second layer forming the back surface of the casing. It may be that the device comprises a third layer between the first and second layers. It may be that the third layer forms part of the casing.

Advantageously, a layered configuration is easy to manufacture and assemble as it has fewer separate component parts that need to be put together in order to assemble the device.

A further advantage is that, by forming the device of different layers, each layer can be selected to provide a particular technical function for the device. For example, the first and second layers may provide connections for electronic components and the third layer may provide structural support for the device. In some cases, one layer can provide multiple functions so the total number of layers of the device is reduced.

In addition, as the third layer separates the first and second layers, there is an improved resistance to flexion compared to if the first and second layers were stacked directly on top of one another. The third layer provides additional structural strength to resist forces which would otherwise cause the device to bend, for example by spacing apart the first and second layers.

It may be that at least one of the first, second and third layers comprises a predetermined shape which is chosen to provide a particular functionality. For example, the first and second layers may be shaped to include apertures through which components of the device can be accessed to allow the user to interact with the device. As another example, the third layer may be shaped to include a spacer which separates the first and second layer from one another and/or to include cavities in which electronic components can be housed. As a further example, the third layer may be shaped so as to provide tactile protrusions for the device, which the user can use to interact with the device. It may be that the tactile protrusions are arranged to extend through the apertures in the first and/or second layer when the device is assembled.

Typically, an outward facing surface of the first layer forms the front surface of the casing. It may be that an inward facing surface of the first layer is internal to the device. Typically, an outward facing surface of the second layer forms the back surface of the casing. It may be that an inward facing surface of the second layer is internal to the device. Typically, the first layer is a top layer of the device. Typically, the second layer is a back layer of the device.

It may be that each of the side surfaces (e.g. top, bottom, left and right surfaces) of the casing are formed of an edge of the first and second layer and a side surface of the third layer.

It may be that the first and second layer are formed of the same material. It may be that the third layer is formed a different material to the first and second layers. Typically, the aperture for receiving the prong therethrough of the device is formed of overlapping apertures in first, second and third layers. It may be that the device comprises three layers exactly.

It may be that at least one of the first layer, the second layer and the third layer is multilaminate. It may be that at least one of the first and second layer comprise a coating sheet as part of the multilaminate. It may be that the coating sheet is intended for use as an external (e.g. outermost) surface of the device. Accordingly, in some embodiments, the coating sheet is the outermost surface of the device.

As an example, it may be that the first layer comprises a front glass coating sheet. It may be that the front glass coating sheet forms the front surface of the device. It may be that the second layer comprises a rear glass coating sheet. It may be that the rear glass coating sheet forms the rear surface of the device.

It may be that the first layer and/or the second layer comprises a PCB adhered to a transparent (e.g. optically clear, colourless) substrate, such as glass. It may be that the PCB adhered to the transparent substrate is a flex PCB. It may be that the PCB is embedded into the transparent substrate. In examples where the first and second layers comprise a flex PCB adhered to a transparent substrate, the communication between the PCBs of the first and second layers is achieved by connection between the two flex PCBs.

It may be that at least one of the first and second layers is a PCB.

Advantageously, provision of the PCB as the layer forming the front surface and/or the back surface further reduces the number of components because the PCB forms part of the casing and the electrical connections. This reduces the complexity of manufacture of the device.

In addition, as PCBs are strong in tension, the device further resists flexion when a force is exerted upon it. Therefore, the device is strong when a PCB is used as the first or second layer, and the strength of the device is further improved when both the first and second layers (i.e. the front and back surface of the casing) are PCBs.

Typically, there are electrical components provided on the PCB of the first and/or second layer. The electrical components may typically be located on the inward facing surface of the PCB of the first and/or second layers. Typically, there are no electronic components on the outward facing surface of the PCB of the first and/or second layers. This is particularly advantageous because the electrical components are protected by the casing.

It may be that the processor is a computing module. It may be that the computing module is provided on the PCB of the first and/or second layer. It may be that the computing module comprises its own further PCB. As an example, it may be that the computing module is a Raspberry Pi (RTM) or other System-On-Module (SOM). In other examples, their may be that a central processing unit and other electronic components mounted directly to the PCB of the first and/or second layer to form a computing module.

It may be that the PCB of the first layer has a thickness of 0.5 mm or less and/or the PCB of the second layer has a thickness of 1 mm or less.

Advantageously, the thinner the PCBs used in the device, the lighter and more compact the device. A light and compact device is particularly useful for portable electronic consumer devices because the device is easy to carry and use ‘on the go’. However by providing a PCB of the back surface which has a greater thickness, the strength of the casing is maintained.

It may be that, when both of the first and second layer are PCBs, the PCB of the first layer is thinner than the PCB of the second layer. It may be that, when the device is assembled, there are no exposed electronic components on either the first or second PCB because they are all on inward facing surfaces of the PCBs.

It may be that the thickness of the PCB of the second layer is greater than the thickness of the PCB of the first layer.

It may be that the PCB of the first layer has a thickness of 0.5 mm or less, for example 0.4 mm or less, such as 0.3 mm or less or for example 0.2 mm or less.

It may be that the PCB of the second layer has a thickness of 1 mm or less. It may be that the PCB of the second layer has a thickness of 0.8 mm or less. It may be that the PCB of the second layer has a thickness of 0.6 mm or less.

It may be that the display screen is offset from the central vertical axis from the front surface of the casing. It may be that the region between the edge of the display screen and the edge of the front surface of the casing extends over a number of electronic components on the first or second PCB, such as the input/output ports mentioned below.

It may be that the elasticity of the third layer varies. It may be that the elasticity of the third layer varies across at least one of its surfaces. It may be that the elasticity of the third layer varies across its back surface. It may be that the elasticity of the third layer varies across its front surface.

Advantageously, by varying the elasticity across the front and/or back surface of the third layer, the third layer can be adapted to have different properties depending on the desired technical function of different portions of the third layer. As an example, in portions of the third layer where the desired property is high strength (e.g. for structural support for the device), these portions may have a low elasticity. As another example, in portions of the third layer where the desired property is high flexibility (e.g. for the user to interact (e.g. actuate) buttons of the device), these portions may have a high elasticity.

It may be that the elasticity of the third layer varies across both of its front and back surfaces.

Typically, the portions of the third layer with a low elasticity may be rigid portions of the third layer. Typically, the portions of the third layer with a high elasticity may be flexible portions of the third layer.

It may be that the elastic modulus of the third layer varies across at least one of its front and back surfaces. It may be that the compressive strength of the third layer varies across at least one of its front and back surfaces. It may be that the stiffness of the third layer varies across at least one of its front and back surfaces. It may be that the flexibility of the third layer varies across at least one of its front and back surfaces.

It may be that the planar electronic device comprises a top portion with an aperture for receiving at least one prong therethrough. It may be that the aperture for receiving the at least one prong is formed by overlapping apertures in the first, second and third layers.

Advantageously, this configuration makes good use of the space within the casing while enabling the device to hang from a looped hook.

It may be that the PCB of the first and/or second layer includes one or more electronic components adjacent to the aperture for receiving the at least one prong.

Typically, when the device is assembled, the first, second and third layers are aligned so that the apertures in each layer overlap with one another to form the aperture for receiving at least one prong therethrough through the entire thickness of the device.

It may be that the third layer is formed of one or more polymer materials.

Advantageously, polymer materials are readily available and strong materials which can be easily moulded into a desired shape and formulated to have desired properties. This is particularly beneficial for the third layer when it has a varying elasticity across its front and back surfaces because the polymer material can have different properties to enable this technical feature to be realised.

It may be that the third layer is formed of one or more (e.g. synthetic) polymer materials. It may be that the polymer material is silicone.

It may be that the third layer is formed of a polymer other than silicone. It may be that the third layer comprises integrated silicone regions, for example to form button actuators. It may be that the third layer is formed using an ‘overmould’ process.

It may be the that third layer comprises regions formed of separate regions of polymer material. It may be that the region of the third layer forming the spacers is formed of a separate piece of polymer material to the piece of polymer material forming the button actuators.

It may be that the polymer material is a thermally conductive polymer. It may be that the third layer is formed of a thermally conductive material. It may be that the thermally conductive material is a metal, e.g. aluminium. It may be that the third layer mates with one or more electronic components of the PCB(s) which typically generated heat (e.g. the processor).

Advantageously, use of the thermally conductive material of the third layer means that the while third layer acts as a heat sink to remove heat from electronic components on the PCB(s).

It may be that the third layer is transparent. It may be that the third layer is colourless. It may be that the third layer is optically clear.

It may be that at least 25% of at least one surface of the PCB of the first and/or second layer is metalized, optionally wherein the metallization is gold.

It may be that the metallization is immersion gold. It may be that the metallization is copper. It may be that the metallization is silver. Typically, such as at least 25%, for example at least 50%, or such as at least 75% of at least one surface of the PCB of the first and/or second layer is metalized.

It may be that the metallization is on the inward facing surfaces of the PCB of the first and/or second layer (e.g. to provide electrical connection between the electronic components mounted thereon).

It may be that the metallization is on the outward facing surfaces of the PCB of the first and/or second layer. It may be that the metallization on the outward facing surfaces of the PCB of the first and/or second layer is used to convey information (e.g. images or text) to the user. It may be that areas on the outward facing surfaces of the PCB of the first and/or second layer are not covered in solder mask.

Advantageously, by shaping the solder mask so that the metallization layer is exposed in desired places on the outward facing surface of the PCB, text and images can be formed on this surface. This is particularly useful because applying solder mask is already part of the manufacturing process to form the traces on the PCB(s) and so no further method step (e.g. printing) is needed to print text and images on the outer surfaces of the device.

It may be that the metallization on the outward facing surfaces of the first and/or second layer comprises regions of printed material (ideally metal, for example gold) to convey information to the user. It may be that the metallization on the outward facing surfaces of the first and/or second layer is formed by providing regions of printed material (ideally metal, for example gold) on the outward facing surfaces. It may be that the regions of printed material (ideally metal, for example gold) comprise an underlayer of a material that is different to the material of the conductive traces on the PCBs. It may be that the underlayer is formed of nickel.

It may be that the information is conveyed to the user by graphics formed on the outward facing surfaces of the first and/or second layer. It may be that the graphics are formed via silk screen printing. It may be that the graphics are formed of a printed material (ideally metal, for example gold). It may be that the graphics are formed during the manufacturing process of the PCB of the first and/or second layer.

It may be that the metallization on the outward facing surfaces of the first and/or second layer is the absence of a coating on the metal (e.g. gold). It may be that the metallization on the outward facing surfaces of the first and/or second layer is formed by removing a coating on the metal (e.g. gold) to expose the metal (e.g. gold) underneath.

It may be that the device comprises one or more spacers within the casing which, with the first and/or second layers, define one or more cavities which retain one or more electronic circuit components.

Advantageously, the provision of electronic circuit components in the cavities protects the components from damage but also provides a compact device with structural support because the spacers define the cavities and provide structural support to the device.

It may be that the one or more electronic circuit components are connected to the PCB of the first layer or the PCB of the second layer. It may be that the one or more electronic circuit components are distributed across the PCB of the first layer and the PCB of the second layer. It may be that there are one or more electronic circuit components on the PCB of the first layer and one or more electronic circuit components on the PCB of the second layer.

It may be that the third layer comprises the one or more spacers and one or more apertures such that the one or more spacers and the one or more apertures of the third layer thereby define one or more said cavities.

Advantageously, the third layer provides a number of different functionalities through the use of spacers and cavities. Typically, the one or more spacers provide a structure which separates the first and second layers from one another so that the PCBs of the first and second layers do not contact one another which could lead to accidental contact between and/or damage to components on the inward facing surface of the PCB of the first and/or second layer. It will be appreciated that the third layer increases the thickness of the device and improves the resistance to flexion of the device, however the increased thickness is kept to a minimum by providing apertures in the third layer to provide cavities in which the electronic circuit components of the PCB(s) can be housed.

It may be that the third layer is formed of a unitary piece, thereby having one spacer. It may be that the third layer is formed of a plurality of pieces, thereby having more than one spacer.

It may be that the one or more cavities extend through the entire thickness of the third layer and are enclosed by the first and second layer. Typically, the one or more cavities are formed by the inward facing surfaces of the first and second layers (where an electronic component may be mounted onto one of these surfaces) and the walls of the spacer which define the aperture of the third layer. In this way, the electronic components may be surrounded by the spacer.

It may be that the one or more cavities extend partially through the third layer and are enclosed on one side by the PCB and on the opposite side by the spacer. Typically, the one or more cavities are formed by the inward facing surfaces of the first or second layers (to which the electronic component may be mounted) and the walls of the spacer which define the aperture of the third layer. In this way, the electronic components may be surrounded by the spacer.

It may be that the one or more electronic circuit components comprise a speaker. It may be that the PCB of the first or second layer and a surrounding spacer enclose the speaker, thereby forming a sound baffle.

Advantageously, the sound baffle directs sound out of the device without requiring provision of a hole in the device through which sound must travel. This reduces the steps required for manufacture as it is not necessary to provide a speaker hole in the first or second layer through which the sound must travel.

It may be that the speaker is mounted to the PCB of the second layer. Since the PCB of the first layer is thin, the sound baffle directs the sound through the PCB of the first layer, which in use will be in the direction towards the user.

Typically, the surrounding spacer refers to the part of the third layer which defines the walls of the aperture of the cavity in which the electronic component (e.g. the speaker) is placed.

In some examples, the PCB of the first and/or the PCB of the second layer may comprise a hole aligned with the speaker so that sound passes through the hole in the PCB.

It may be that the third layer comprises a spacer comprising at least one fixed portion and at least one actuator portion which defines one or more button actuators. It may be that the at least one fixed portion has a lower elasticity than the one or more buttons actuators.

Advantageously, the fixed portion and the at least one actuator portion provide different functionalities because the fixed portion does not move and has a lower elasticity than the button actuators. This means that the fixed portion provides structural rigidity to the device and the button actuators allow the user to interact with the device by pressing buttons.

It may be that the fixed portion comprises the one or more cavities for the electronic components. It may be that the at least one actuator portion comprises the one or more cavities for the electronic components. It may be that the at least one actuator portion is in contact with the electronic components of the corresponding buttons when the device is assembled and actuates the buttons when pressed.

It may be that the electronical components which form the contacts for the buttons on the respective PCB(s) are adhered (e.g. using tape or by hand) to the PCB. It may be that the electronical components which form the contacts for the buttons on the respective PCB(s) are reflow soldered to the PCB during the manufacturing process.

It may be that at least one of the first and second layer comprise one or more apertures. It may be that at least one of the button actuators of the spacer is exposed through one of the one or more apertures.

Advantageously, since the button actuators are exposed on the exterior of the device, the button actuators are accessible to the user for use in interacting with and controlling the device.

It may be that the third layer comprises an elastic sheet portion which forms the contact surface of the buttons which the user touches to actuate the buttons. It may be that the contact surface of the buttons is textured to provide a tactile surface to the user. It may be that the contact surface of the buttons is different to the PCB casing on the front and back surface. It may be that a front side of the third layer forms the contact surface of the buttons on the front surface of the device. It may be that a back side of the third layer forms the contact surface of the buttons on the back surface of the device.

It may be that the button actuators are formed on the front surface of the third layer so that the button actuators are exposed on the front surface of the casing. It may be that the buttons actuators are formed on the rear surface of the third layer so that the buttons actuators are exposed on the rear surface of the casing. It may be that the button actuators overlap electronic components on the first and/or second PCB when the device is assembled so that physical movement of the buttons causes an input to the device.

It may be that at least one of the one or more button actuators extends through the respective aperture in the first or second layer. It may be that at least one of the one or more button actuators protrudes beyond the front or back surface of the casing.

Advantageously, since the button actuators protrude from the electronic device, the button actuators are more tactile compared to if they were flush against the front or back surface of the casing. This improves the usability of the device because the buttons are easily accessible and can be quickly located. This is particularly advantageous when the electronic device is used as a gaming device because quick location and actuation of buttons is often desired when playing a computer game.

Typically, the apertures in the first and/or second layer define the periphery of the buttons on the front or back surface of the casing.

It may be that at least one of the one or more button actuators protrudes beyond the front or back surface of the casing in that the button actuators are raised with respect to the front or rear surface of the casing. Typically, the one or more button actuators extend from the front and/or back surface in a direction perpendicular to the surface.

Typically, the button actuator may protrude by, for example at most 0.3 mm, such as at most 0.2 mm, for example at most 0.1 mm for the front and/or rear surface of the casing of the device.

When the third layer comprises button actuators to form the one or more clusters of buttons on the front surface and one or more buttons on the rear surface, the button actuators on the front and back surface of the third layer are offset from one another (i.e. the front button actuators do not overlap the rear button actuators) Advantageously, this means that actuation of each button can be made independently so that accidental actuation of an overlapping button does not occur.

It may be that the device comprises one or more side button actuators on a side surface of the casing. It may be that the device comprises one or more input/output ports on a side surface of the casing of the device.

Advantageously, further functionality is provided to the device by the side button actuators and input/output ports by using the side surfaces of the device. This means that the device remains compact even whilst having this further functionality because the device does not need to be made bigger in order to provide these components on the front or back surface of the casing.

It may be that the side button actuators correspond to buttons which are typically used less frequently than the buttons of the button actuators on the front or back surface of the device. For example, the side button actuators may correspond to a power button, a menu button and/or a function button. The button actuators on the front and/or back surface of the device may correspond to left/right/up/down buttons and/or lettered buttons, which are used most often to control the device when it is being used.

It may be that the side button actuators are located between the first and second layers in line with the aperture for receiving the prong. Typically, the side button actuators are positioned on a side surface of the casing aligned, in the direction from the top surface to the bottom surface of the device, with the aperture for receiving the prong therethrough. Advantageously, using the space adjacent to the aperture for receiving the prong therethrough to provide electronic components means that the device is more compact because the amount of empty space on the PCB (i.e. PCB space not used for an electronic component or connection) is reduced.

It may that the input/output ports facilitate connection of the device to an external electronic device. It may be that the input/output ports include one or more of: an audio input/output port, display screen output port and charging port. It may that the input/output ports facilitate data transfer between the device and an external device.

It may be that at least one of the one or more input/output ports are integral parts of the computing module.

It may be that the one or more input/output ports are positioned to the side of the display screen. It may be that the one or more input/output ports are aligned so that they open onto one of the side surfaces of the devices.

It may be that the device comprises a wireless communication module. It may be that the wireless communication module is configured to communicate with external device using one or more of Wi-Fi or Bluetooth. In this example, it may be that the device does not comprise any input/output ports for wired communication with external devices.

Optionally, the device may comprise a wireless charging module. It may be that the wireless charging module comprises a wireless charger coil formed in tracks on the on the PCB of the first or second layer. In this example, it may be that the device does not comprise any charging ports for wired charging, though both wired and wireless charging may be achieved by provision of a wireless changing module and a charging port in the device.

It may be that third layer comprises the one or more side button actuators. It may be that the PCB of the first or second layer comprises an electronic component for each of the side button actuators.

Advantageously, the side button actuators on the third layer provide an additional functionality to the third layer in that it also allows the user to interact with the device by pressing buttons on the side of the device.

Since the side surfaces of the casing are formed by the edges of the third layer, the side button actuators are easily accessible to the user. It may be that the one or more side button actuators protrude from the side surface of the device (e.g. in a direction perpendicular to the surface).

Typically, the PCB of the first and/or second layer comprises a side mounted electronic component which sits beneath each of the side button actuators. When the device is assembled, the side button actuators of the third layer can be pressed into the device by the user to actuate the side buttons. It may be that the side mounted electronic components are physical surface-mount technology (SMT) micro push buttons. It may be that the physical SMT micro push buttons are soldered to PCB of the second layer.

It may be that wherein at least one of the one or more side button actuators protrudes beyond the edge of the front or back surface of the casing.

Advantageously, since the side button actuators protrude from the side surface of the electronic device, the side button actuators are more tactile compared to if they were flush against the side of the device. This improves the usability of the device because the buttons are easily accessible and can be quickly located.

It may be that the side button actuators of the third layer have a greater elasticity than the fixed portion of the third layer. It may be that the side button actuators of the third layer have the same elasticity as the button actuators of the third layer for the buttons on the front and back surfaces of the device. This means that the side button actuators allow the user to interact with the device by pressing the side buttons.

It may be that at least one of the one or more side button actuators protrude beyond the side surface of the casing in that the side button actuators extend from the respective side surface in a direction perpendicular to the surface. It may be that the protrusion of the side button actuators defines the widest part of the device.

Typically, the side button actuators may protrude by, for example at most 0.3 mm, such as at most 0.2 mm, for example at most 0.1 mm for the side surface of the casing of the device. It may be that the electrical components for the side button actuators are retained in respective cavities in the third layer.

It may be that the one or more input/output ports are connected to the PCB of the first or second layer. It may be that the third layer comprises one or more recesses. It may be that each recess is configured to accommodate at least one of the one or more input/output ports therein.

Advantageously, the third layer provides an opening for the input/output ports so that a cable can be inserted into the device. By providing the input/output ports in cavities in recesses in the third layer, the thickness of the device is kept to a minimum because the ports are mounted to the PCB of the first and/or second layer and housed in the recesses of the third layer.

It may be that the PCB of the first or second layer comprises a first region in which no electrical contact is present, and no solder mask is applied. It may be that the first region overlaps a light emitting device within the casing.

Advantageously, since no solder mask is applied to the region of the PCB which covers the light emitting device, the light passes through that PCB more easily than if that region were covered in solder mask. This reduces the steps required for manufacture as it is not necessary to provide a hole in the first or second layer through which the light can be seen.

It may be that having no electrical contact present refers to the lack of electronic components mounted to the PCB in that region. It may be that having no solder mask present on the PCB refers to a lack of lacquer-like material on the PCB.

Typically, the light emitting device is a light emitting diode (LED). Typically, the light emitting device is mounted to the PCB of the second layer. Typically, the light emitting device is an electronic component retained within a cavity of the third layer. Typically, the light emitting device is enclosed by the PCB of the first layer and the walls of the spacer which form the aperture defining the cavity in the third layer. Typically, the PCB of the first layer comprises the first region so that the light is seen through the front surface of the casing. In other examples, the light emitting device may be mounted to the PCB of the first layer such that the light is seen on the back surface of the casing through the PCB of the second layer.

It may be that the third layer comprises an integral waterproof seal (e.g. typically a gasket). Advantageously, the integral waterproof gasket is easy to manufacture as part of the third layer and causes the device to be waterproof.

It may be that both the first layer and the second layer comprise a PCB. It may be that the PCBs of the first and second layer communicate with one another using a connector.

Advantageously, the connecting PCB allows for communication between the PCB of the first layer and the PCB of the second layer. The connecting PCB may provide electronic connection between the PCBs of the first and second layers.

It may be that the connector is a connection between corresponding connector pins. It may be that the connection is formed by mating board-to-board connectors. It may be that that the pins are SMT components. It may be that the SMT components are attached to the respective PCB and connected together as part of the assembly process.

It may be that the connector is a connecting PCB. It may be that the connecting PCB is a flex PCB. It may be that the flex PCB is soldered to at least one of the PCBs of the first and second layer. It may be that the flex PCB plugs into a connector socket on at least one of the PCBs of the first layer and the second layer.

It may be that the PCBs of the first and second layer are rigid PCBs. In some examples, the PCB of the first and/or second layer may comprise a flex rigid PCB.

It may be that the PCBs of the first and second layer and connecting PCB are manufactured as one single part using flex-rigid PCB process.

It may be that the flex PCB (which may be approximately 0.1 mm in thickness) is connected (e.g. soldered) to the PCB of the second layer and plugs into a connector socket on the PCB of the first layer during assembly.

In an example, the device may not comprise a SOM (system-on-module) but does comprise the flex PCB to communicate between boards.

It may be that the planar electronic device has a unique visual indicator visible on the casing, this unique visual indicator is usable to download one or more software applications to the planar electronic device or to activate one or more software application prerecorded on the planar electronic device. The unique visual indicator may for example be a number, an alphanumeric code, a QR-code etc. It may be that the device is activated at the points of sale, for example using a wireless communication device, or the visual indicator.

It may be that the device comprises one or more further visual indicators. It may be that at least one of the one or more further visual indicator comprises a QR code for an affiliate programme.

It may be that the device comprises one or more physical external components. It may be that the one or more physical external components are peripheral devices. It may be that the one or more physical external components provide auxiliary functions to the device. It may be that the one or more physical external components include at least one of: a knife, a first aid kit and compass.

It may be that the display screen is a touchscreen.

It may be that the device comprises a peripheral component for interacting with the display screen. The peripheral component for interacting with the display screen may be removably attached to the planar electronic device. For example, the peripheral component may be a stylus. The electronic planar device may comprise a receiving member for receiving the peripheral component for interacting with the display screen. For example, the receiving member may comprise a clip, recess or cavity configured to receive the peripheral component.

The invention extends to display stand having one or more looped hooks protruding therefrom and on at least one looped hook, a plurality of planar electronic devices according to any previously described electronic device hanging therefrom by virtue of the at least one prong passing through their aperture for receiving the at least one prong.

It may be that the plurality planar of devices are not individually wrapped (with a removable and disposable wrapper). It may be that the plurality planar of devices are transported with the casings of adjacent devices in contact with each other (e.g. the first layer of one device touching the second layer of an adjacent device) (and so without any wrapping therebetween). The construction described herein is sufficiently robust to allow wasteful excess packaging to be dispensed with.

In a second aspect there is provided a method of construction of a planar electronic device according to the first aspect. It may be the method comprises mounting the display screen to a PCB. It may be that the method comprises mounting a power storage module to the PCB. It may be that the method comprises mounting one or more electronic components to the PCB. It may be that the method comprises wrapping a creased sheet comprising a display screen aperture around the PCB such that the display screen is visible through the display screen aperture and the creased sheet forms the casing of the planar electronic device.

The method may comprise fitting one or more spacers on the PCB (typically the front surface) or the casing, the one or more spacers defining one or more cavities within which one or more components attached to the PCB are located, the one or more spacers holding the casing away from the PCB.

This arrangement gives the device structure and protects the one or more components mounted to the PCB.

The method may further comprise mounting a plurality of button electrical contacts to the PCB and forming at least one spacer which comprises at least one fixed portion and at least one actuator portion which defines one or more button actuators and forming one or more user actuatable button formations on the exterior of the casing (typically the creased sheet) such that the one or more button actuators and the one or more user actuatable button formations overlay the button electrical contacts in the planar electronic device. A user may operate a button by pushing a user actuatable button formation, leading to opening or closing the respective electrical contact. Typically, the force is transmitted by the respective button actuator.

It may be that the method comprises mounting a plurality of button electrical contacts to the PCB and forming one or more user actuatable button formations on the exterior of the creased sheet such that they overlay the button electrical contacts in the planar electronic device.

The method may comprise placing the PCB on the casing. In this way, when the casing is folded, the cavities in the spacer align with the position of electronic components on the PCB.

It may be that the method also comprises forming a metal layer on the PCB to strengthen the electronic device. The method may comprise forming metal regions which do not conduct signals in gaps between metal tracks, to thereby strengthen the PCB.

The present invention provides a number of significant benefits to the field of planar hand-held electronic devices with screens. The reinforcing metal regions on the PCB strengthen the electronic device compared to if the electronic device were formed of the PCB and cardboard casing only. In addition, the spacers between the casing and the PCB further improve the strength of the electronic device. As a result, each of these features reduce the flexibility of the electronic device and strengthen the electronic device. This enables a material like cardboard, which is a particularly advantageous material because it is light, readily available, environmentally friendly and easier to recycle than existing technologies, to be used for the casing.

In addition, the aperture, display screen, power storage module and controls are positioned to form a compact arrangement. This reduces the overall size and cost of the device whilst providing a convenient portable handheld device, which is suitable as a game console, for example. By locating electronic components within the spacers, the spacers provide two functions, i.e. they strengthen the electronic device and house the electronic components to protect the components whilst also reducing the space required in the device.

According to a further aspect of the invention, there is provided a method of construction of a planar electronic device as described above. It may be that the method comprises mounting one or more electronic components to a first PCB. It may be that the method comprises mounting the display screen, a battery and one or more further electronic components to a second PCB. It may be that the second PCB comprises a display screen aperture. It may be that the method comprises providing a third layer between the first and second PCBs such that the display screen is visible through the display screen aperture. It may be that the first PCB forms the front surface of the casing of the planar electronic device and the second PCB forms the back surface of the casing of the planar electronic device.

Advantageously, provision of two PCBs which form the front and back surfaces of the casing of the device reduces the number of components because the PCBs provide both the connections for the electronic components of the device and also the casing of the device. A manufacturing method of assembling a layered device is less complex to manufacture than existing technologies.

It may be that the device is permanently assembled once manufactured such that separating the layers would damage the device. For example, it may be that the method comprises assembling the first, second and third layers using adhesive.

It may be that the device is capable of disassembly and reassembly without damaging the device. For example, it may be that the method comprises assembling the first, second and third layers using releasable fasteners, such as corresponding magnets on each of the layers, or a screw through screw holes formed in each of the layers. It will be appreciated that other methods of assembly will be envisaged. Since the device can be reassembled, this allows components of the device to replaceable, for example the power storage module.

It may be that the method comprises forming one or more spacers in the third layer. It may be that the one or more spacers define one or more cavities within which one or more components attached to the first and/or second PCB are located.

Advantageously, the third layer includes cavities which are arranged to provide space for the electronic components attached to the first and/or second PCB. Therefore, when assembling the device, the third layer can simply be placed over the second PCB by aligning the cavities with the electronic components of the second PCB and the first PCB can simply be placed over the third layer by aligning the cavities with the electronic components of the first. PCB.

It may be that the method comprises mounting a plurality of button electrical contacts to the first and/or second PCB. It may be that the method comprises forming at least one spacer in the third layer which comprises at least one fixed portion and at least one actuator portion which defines one or more button actuators. It may be that the method comprises providing each of the one or more button actuators in a corresponding aperture on the first and/or second PCB, such that the one or more button actuators overlay the button electrical contacts in the planar electronic device.

Advantageously, the device can be easily assembled by aligning the button actuators of the third layer with the corresponding button electrical contact on the first or second PCB and the corresponding aperture in the other PCB.

It may be that the method comprises forming the third layer from a first material and a second material. It may be that the first material has a lower elasticity than the second material.

Advantageously, by varying the elasticity across the front and/or back surface of the third layer, the third layer can be adapted to have different properties depending on the desired technical function of different places on the third layer.

It may be that the method comprises forming the third layer using a two-shot moulding process. It may be that the two-shot moulding process comprises a first stage and a second stage. It may be that in the first stage, the first material is moulded and in the second stage, the second material is moulded, or vice versa.

It may be that the electronic device described above is a gaming device. It may be that the electronic device described above is a musical instrument (e.g. a synthesizer). It may be that the electronic device described above is a torch. It may be that the electronic device is a communications device. It may be that the electronic device is a mobile phone. It may be that the electronic device is a long-range handheld transceiver. It may be that the electronic device is a power storage device. It may be that the planar electronic device is a survival kit version, which is a survival kit. It may be that the planar electronic device comprises a compass.

Optional features described in relation to any aspect of the invention are optional features of each aspect of the invention.

### DESCRIPTION OF THE DRAWINGS

An example embodiment of the present invention will now be illustrated with reference to the following Figures in which:

FIGS. 1 and 2 illustrate an electronic device according to an aspect of the present invention;

FIG. 3 illustrates a casing of an electronic device according to an aspect of the present invention;

FIG. 4 illustrates an electronic device according to an aspect of the present invention;

FIGS. 5 and 6 illustrates a schematic of a circuit board of an electronic device according to an aspect of the present invention;

FIG. 7 illustrates an electronic device according to an aspect of the present invention;

FIGS. 8, 9 and 10 illustrate construction of an electronic device according to an aspect of the present invention;

FIG. 11 illustrates an electronic device according to an aspect of the present invention;

FIGS. 12 and 13 illustrates another electronic device 300 according to an aspect of the present invention;

FIG. 14 illustrates an exploded view of an electronic device according to an aspect of the present invention;

FIG. 15 illustrates an electronic device according to an aspect of the present invention;

FIG. 16 illustrates an apparatus according to an aspect of the present invention;

FIG. 17 illustrates a flowchart of a method according to an aspect of the present invention;

FIG. 18 illustrates a schematic of an electronic circuit of an electronic device according to an aspect of the present invention;

FIGS. 19 to 30 illustrate an electronic device according to according to a further example of the present invention;

FIG. 31 illustrates a flowchart of a method according to a further example of the present invention; and

FIG. 32 illustrates a schematic of part of an apparatus according to an aspect of the present invention.

### DETAILED DESCRIPTION OF AN EXAMPLE EMBODIMENT

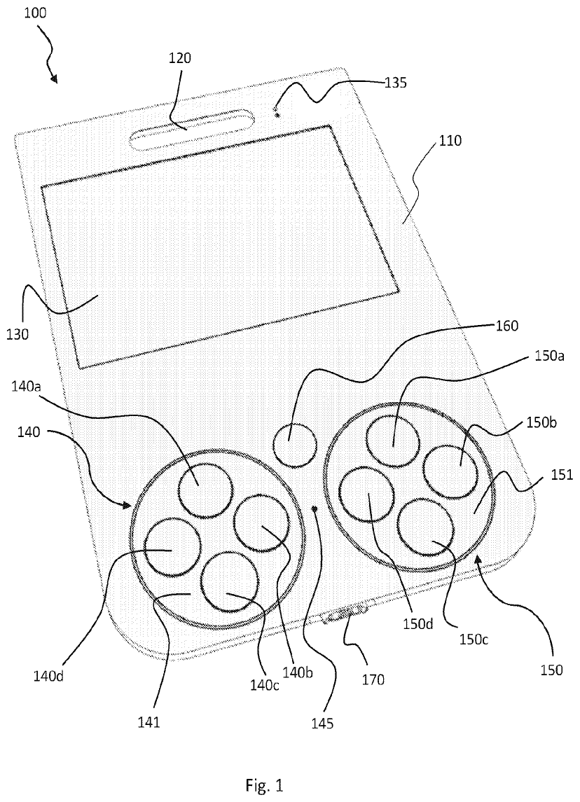

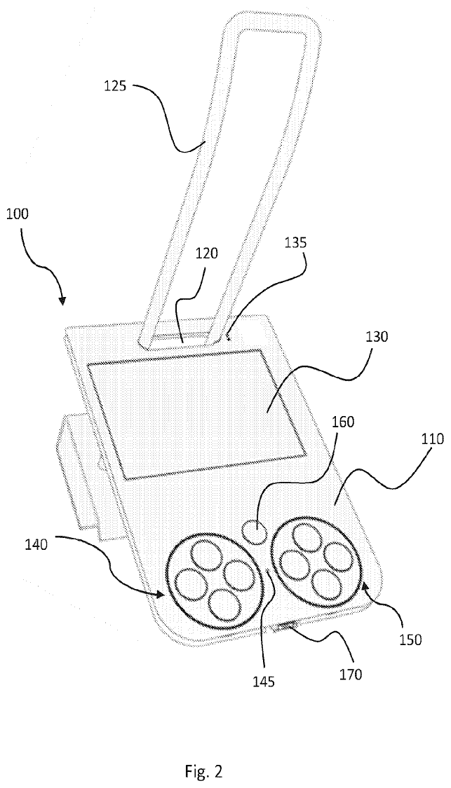

FIGS. 1 and 2 illustrate an electronic device 100 according to an aspect of the present invention. The electronic device 100 is a handheld games console. The electronic device is formed of a cardboard casing 110 which is gripped by a user when holding and using the electronic device 100. The cardboard casing 110 includes a slot 120 which extends through the entire thickness of the cardboard casing. The slot 120 is located in a top portion of the electronic device 100. The slot 120 allows the electronic device 100 to hang from a looped hook 125 of a display stand. In an example embodiment, the slot 120 has dimensions of 32 mm (width)×6.5 mm (height) and the cardboard casing has dimensions of 89 mm (width)×128 mm (height)×0.4 mm (thickness).

The electronic device 100 includes an LCD display screen 130 positioned in a display region of the electronic device 100. The display screen 130 depicts visuals of the game to the user. The electronic device 100 includes a first cluster of buttons 140 and a second cluster of buttons 150 which are used by the user to control and interact with the electronic device 100, for example to navigate through a menu displayed on the display screen 130, move an object displayed on the display screen 130, or data entry. The first cluster of buttons 140 comprises 4 buttons 140a, 140b, 140c, 140d which are individually actuatable by the user. The second cluster of buttons 150 comprises 4 buttons 150a, 150b, 150c, 150d which are individually actuatable by the user. The first and second clusters of buttons 140, 150 are located in a user input region of the electronic device 100.

The button 140a is an up button. The button 140b is a right button. The button 140c is a down button. The button 140d is a left button. The button 150a is an X button. The button 150b is an A button. The button 150c is a B button. The button 150d is a Y button (X, Y, A, B buttons are industry standard for gaming console controllers). The first cluster of buttons 140 includes a first button divider 141 which surrounds the buttons 140a, 140b, 140c, 140d to protect the buttons whilst still allowing a user to press the buttons 140a, 140b, 140c, 140d. The second cluster of buttons 150 includes a second button divider 151 which surrounds the buttons 150a, 150b, 150c, 150d whilst still allowing a user to press the buttons 150a, 150b, 150c, 150d.

The electronic device 100 includes a power button 160 located in the user input region of electronic device 100. The power button 160 is used to turn the electronic device 100 on, and potentially off. The electronic device 100 includes a port 170 for connecting accessories. The port 170 may be used to charge the electronic device 100, connect the electronic device 100 to another electronic device, or connect electronic accessories, such as earphones. The electronic device 100 also includes an additional input device 145, which is a microphone. The electronic device 100 includes an additional output device 135, which is a speaker. Although not shown in FIGS. 1 and 2, it will be appreciated that there may be a plurality of ports, for connecting to various types of external devices or components of the electronic device.

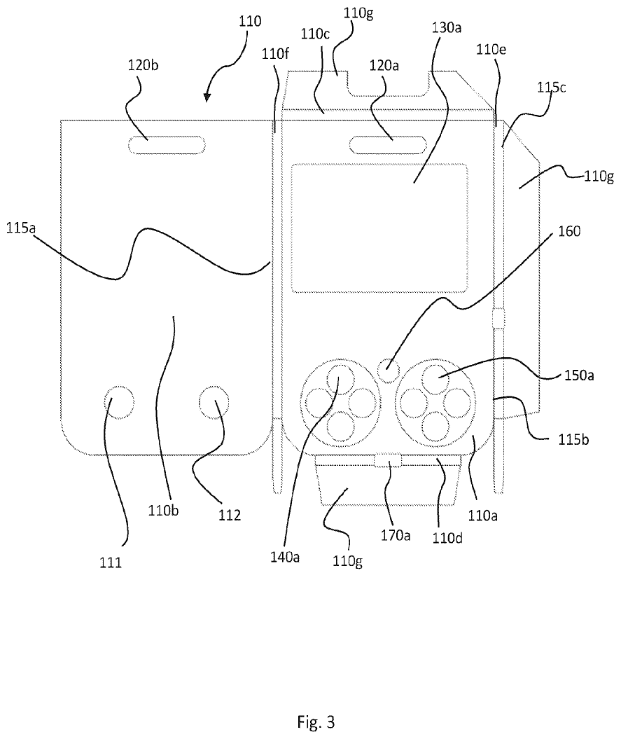

FIG. 3 illustrates a net of the casing 110 of an electronic device 100 according to an aspect of the present invention. The holes for the speaker 135 and the microphone 145 have been omitted for this Figure and may not be a part of the planar electronic device. That is, the electronic device may include the speaker 135 and microphone 145 but not include openings in the casing for these components. The casing 110 includes various surfaces and openings to accommodate components of the electronic device 100 therein. The edges of each of the surfaces are formed by a crease so that the housing is easy to fold along predefined lines. The net is folded together to house the components of the electronic device 100. The net shows the surfaces that would be exterior to the electronic device 100 when assembled, i.e. folded. For the purposes of this description, the references to the various surfaces are intended to correspond to the surface that would be the corresponding external surface when the electronic device 100 is assembled, i.e. folded.

The casing 110 includes a front surface 110a. The front surface 110a has a front slot opening 120a which forms the slot 120 to allow the electronic device to hang on the hook 125. The front surface 110a has a display screen opening 130a, functioning as the display aperture, to house the display screen 130.

The casing 110 has a rear surface 110b which has a rear slot opening 120b, which is positioned behind the front slot opening 120a, when the casing 110 is folded. The rear surface 110b includes the first rear button 111 and the second rear button 112, functioning as user actuatable button formations on the casing 110.

The casing 110 has a top surface 110c, forming the top end of the electronic device 100. The casing 110 has a bottom surface 110d, forming the bottom end of the electronic device 100. The casing 110 has a left surface 110f, forming the left side of the electronic device 100. The casing 110 has a right surface 110e, forming the right side of the electronic device 100. The casing 110 has joining surfaces 110g which are used to form the electronic device 100 when the casing 110 is folded. The joining surface 110g are used to secure the electronic device 100 when folded. The joining surfaces 110g may be glued to the interior surfaces of the casing 110. The predefined lines, which are creases along the edges of the various surfaces are shown by examples 115a, 115b, 115c.

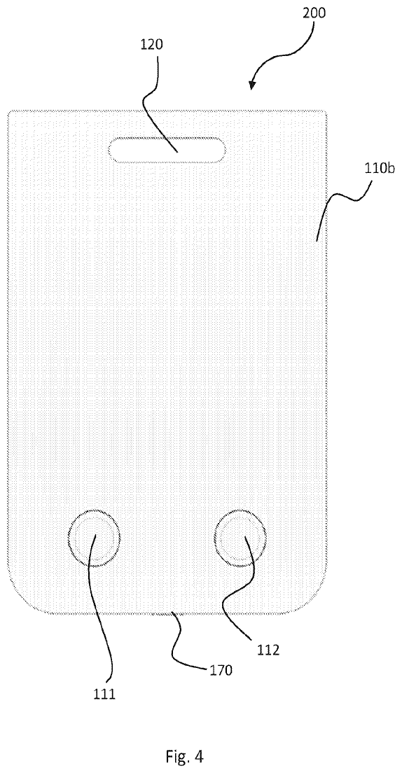

FIG. 4 illustrates a rear surface 110b of then electronic device 100 according to an aspect of the present invention. The rear surface 110b includes the rear buttons, namely the first rear button 111 and the second rear button 112.

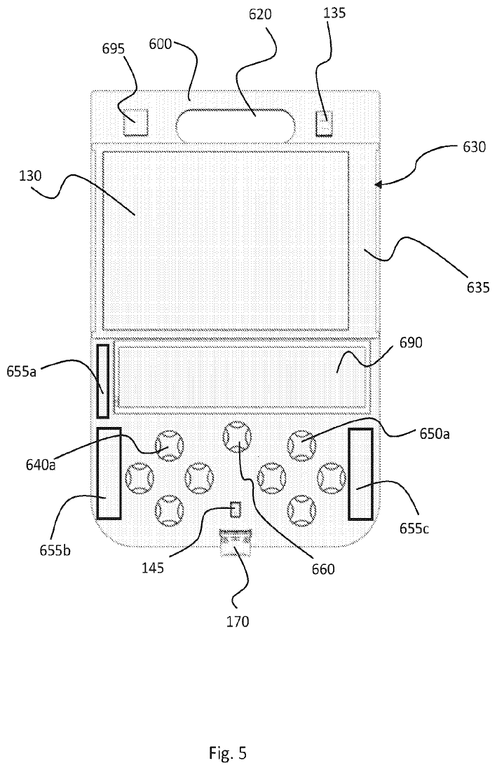

FIG. 5 illustrates a schematic of a printed circuit board, PCB, 600 of an electronic device 100 according to an aspect of the present invention. The PCB 600 is assembled and includes various features and components of the electronic device 100. The PCB 600 includes a PCB slot 620 which overlaps the front and rear slot openings 120a, 120b of the casing 110 when the electronic device 100 is put together. The PCB 600 may include reinforcing metal regions. The PCB 600 includes an electronic display unit, indicated generally by reference numeral 630, which includes the display screen 130 and electronic driver circuitry 635. That is, the display screen 130 and the electronic driver circuity form a single unit, of the electronic display unit. As shown in the Figures, the display screen 130 is offset from the lateral centre, i.e. not equidistant to the left and right surfaces 110e, 110f, because the electronic driver circuitry 635 close to the display screen 130 to make the electronic device 100 more compact. It will be appreciated that the PCB 600 shown in FIG. 5 may also include ancillary components, such as capacitors and resistors, that are not illustrated for simplicity.

The PCB 600 includes a battery 690, functioning as a power storage module, located in a battery region of the electronic device 100, which can be recharged using a charger connected the port 170. The battery extends across the lateral width of the PCB 600. The PCB 600 also includes a processor 695 which could be formed on an integrated circuit. The speaker 135 and the microphone 145 are typically included as components on the PCB 600. The processor 695 and the speaker 135 are typically located in a top portion of the PCB 600, i.e. near the top surface 110c.

The PCB 600 includes a number of dome switch buttons, including first dome switch button 640a which corresponds to up button 140a from the first cluster of buttons 140, second dome switch button 650a which typically corresponds to X button 150a from the second cluster of buttons 150. For clarity, only a subset of the dome switch buttons have been labelled. However, it will be appreciated that each button has a corresponding dome switch button on the PCB.

Beginning from the top surface 110c and moving to the bottom surface 110d, the electronic device 100 includes a top portion, a display region, a battery region and user input region.

The PCB 600 includes a number of metallized regions 655a, 655b, 655c. The metallized regions 655a, 655b, 655c provide a supportive structure to strengthen the electronic device. The metallized regions 655a, 655b, 655c form a metal layer which fill in space between conductive tracks between components (not illustrated). There is a small gap between the metal regions and the signal conducting tracks to prevent the metal regions being part of the conductive tracks.

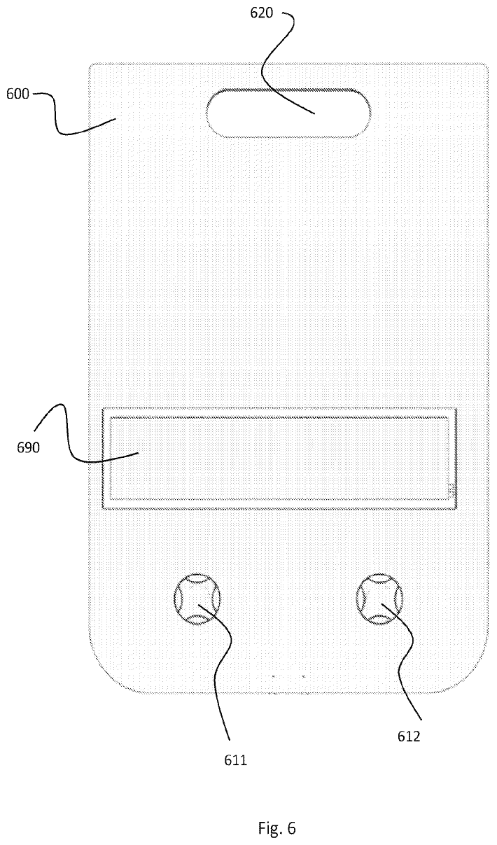

FIG. 6 illustrates a schematic of the rear surface of the printed circuit board, PCB, 600 of the electronic device 100 according to an aspect of the present invention. The PCB 600 includes a number of dome buttons, including first rear dome button 611 and second rear dome button 612. The PCB 600 includes a PCB slot 620 which overlaps the slot 120 of the casing 110 when the electronic device 100 is put together. The rear side of the PCB also shows the battery 690. In other words, the battery 690 is fitted in a cavity that extends through the entire thickness of the PCB such that it is exposed on both the front and rear surfaces of the PCB. The rear surface of the PCB 600 may also comprise metallized regions (not illustrated).

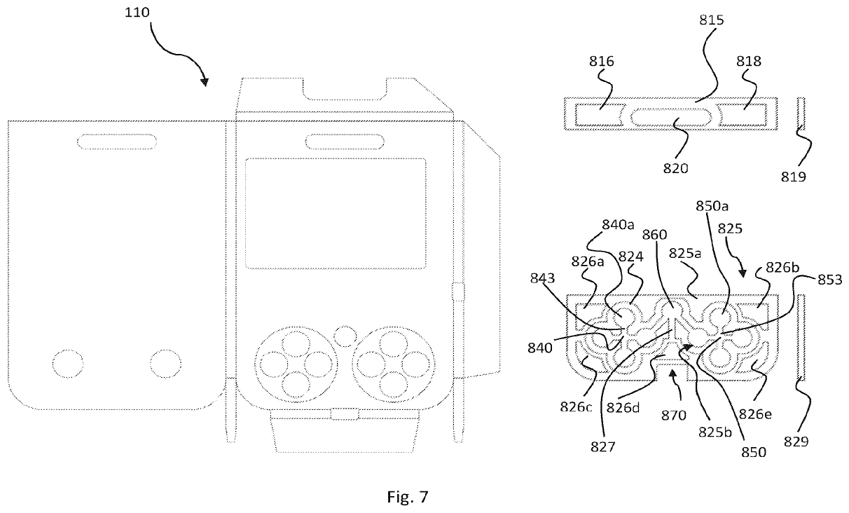

FIG. 7 illustrates an electronic device 100 according to an embodiment of the invention. The same net of the casing 110 as shown in FIG. 3 is repeated to show alignment with the cardboard spacers 815, 825. Side views 819, 829 of the spacers are also shown. The spacers 815, 825 extend across the lateral width of the electronic device 100. The spacers 815, 825 include a number of apertures. The spacers 815, 825 are placed between the interior surface of the front surface 110a of the casing 110 and the PCB 600 and thereby define cavities for housing electronic components of the electronic device 100. The cavities have a base formed by the PCB, sides formed by the edges of the apertures of the spacers 815, 825 and an electronic component is contained therein. The casing 110a forms the cover for some of the cavities to protect the electronic components, as is the case for the processor 695. The casing 110a forms a partial cover for some of the cavities to protect the electronic components, as is the case for the speaker 135 and the microphone 145.

The spacer 815 is formed of one continuous structure with two apertures 816, 818 and is located in a top portion of the electronic device 100. The aperture 816 is located to the left of the spacer slot 820 and houses the processor 695. The aperture 818 is located to the right of the spacer slot 820 and houses the speaker 135. The spacer slot 820 overlaps with the front and rear slot openings 120a, 120b of the casing 110 when the electronic device 100 is folded (i.e. put together).

The spacer 825 is formed of one continuous structure comprising two different regions, namely the outer region 825a, which is a fixed spacer portion, and button actuator region 825b. There is a gap 824 between the outer region 825a and the button actuator region 825b. However, the outer region 825a and the button actuator region 825b are connected by centre link 827, which functions as a single branched spacer portion. The button actuator region 825b is moved towards the corresponding dome switch buttons 640a, 650a on the PCB 600 when the user presses the buttons 140a, 150a on the electronic device 100. The spacer 825 includes a number of apertures. The apertures 826a, 826b, 826c 826d, 826e house various electronic components, such as resistors, capacitors and/or a camera module.

The button actuator region 825b has a power switch actuator 860 which is moveable in response to the user pressing the power button 160. The button actuator region 825b includes a first switch actuator 840, located to the left of the power switch actuator 860, which is moveable in response to the user pressing the first cluster of buttons 140. As an example, the first switch actuator 840 has an ‘up’ button actuator 840a corresponding to button 140a. It will be appreciated that the first switch actuator 840 has button actuators for the other buttons 140b, 140c, 140d. The button actuator region 825b includes a second switch actuator 850, located to the right of the power switch actuator 860, which is moveable in response the user pressing the second cluster of buttons 150. As an example, the second switch actuator 850 has an X button actuator 850a corresponding to button 150a. It will be appreciated that the second switch actuator 850 has button actuators for the other buttons 540b, 540c, 540d. Each of the individual button actuators 840a, 850a are connected by button links, such as button link 843, 853, which function as branched flexible spacer portions.

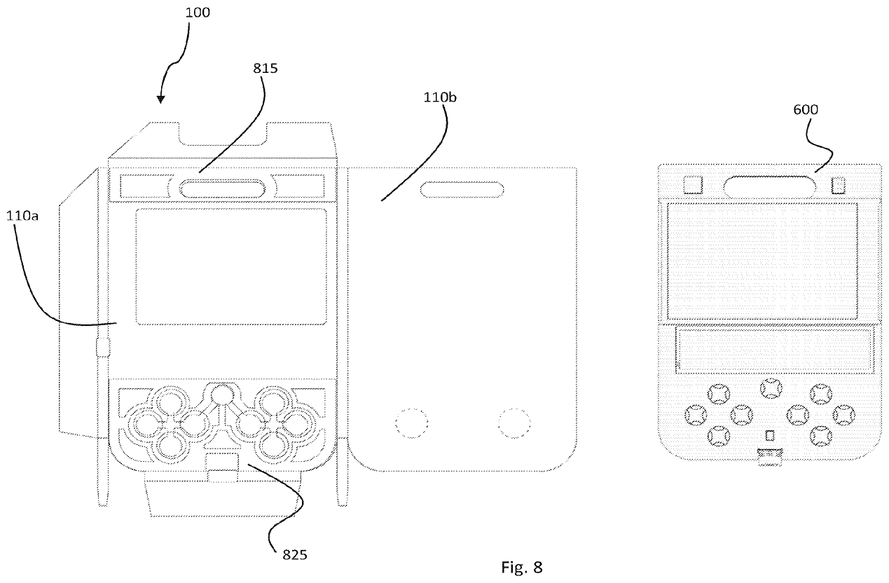

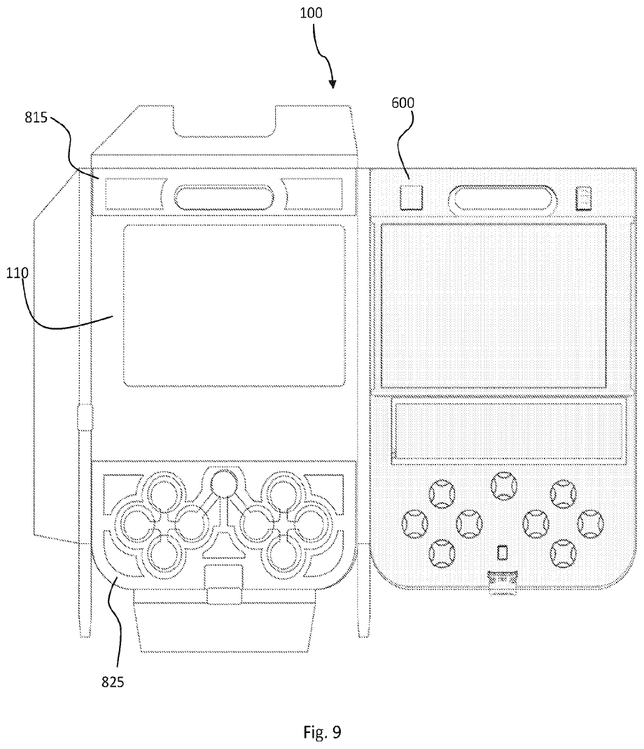

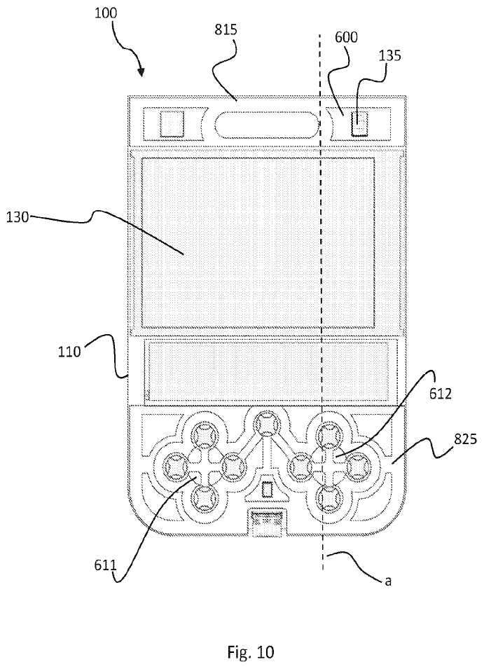

FIGS. 8, 9 and 10 illustrate construction of an electronic device 100 according to an aspect of the present invention. The electronic device 100 is formed by placing the spacers 815, 825 on the interior of the front surface 110a of the casing 110. The PCB 600 is placed on the interior of the rear surface 110b of the casing 110. The electronic device 100 is formed by folding the interiors of the front surface 110a and the rear surface 110b towards one another, such that the spacers 815, 825 and the PCB 600 are housed within the casing 110. FIG. 10 shows the electronic device 100 as though the casing 110 was transparent in order to illustrate the overlapping of the various layers (i.e. the front surface 110a of the casing 110, the spacers 815, 825, the dome switch buttons on the front surface of the PCB, the rear dome buttons on the rear surface of the PCB and the rear surface 110b of the casing 110 (which is not illustrated as this is the same shape of the front surface of the casing 110)). The cavity in which the speaker 135 sits, which is formed by the spacer 815 performs the function of a loudspeaker enclosure.

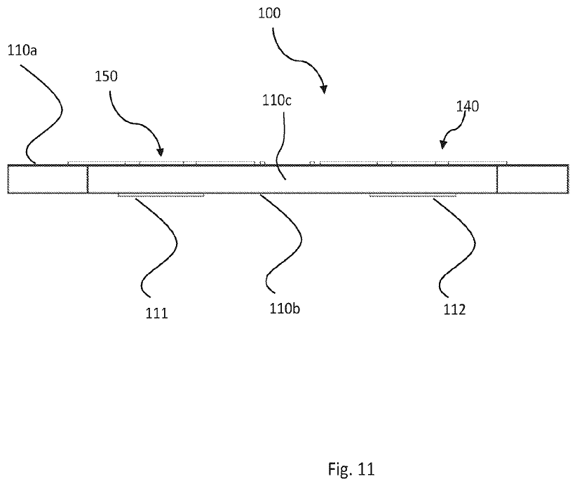

FIG. 11 illustrates a simplified view of the top surface 110c of the electronic device 100 according to an aspect of the present invention along line ‘a’ when the front surface 110a faces upwards and the rear surface 110b faces downwards. The first and second cluster of buttons 140, 150 are shown on the upper surface 110a of the electronic device 100. The first and second rear buttons 111, 112 are shown on the rear surface 110b.

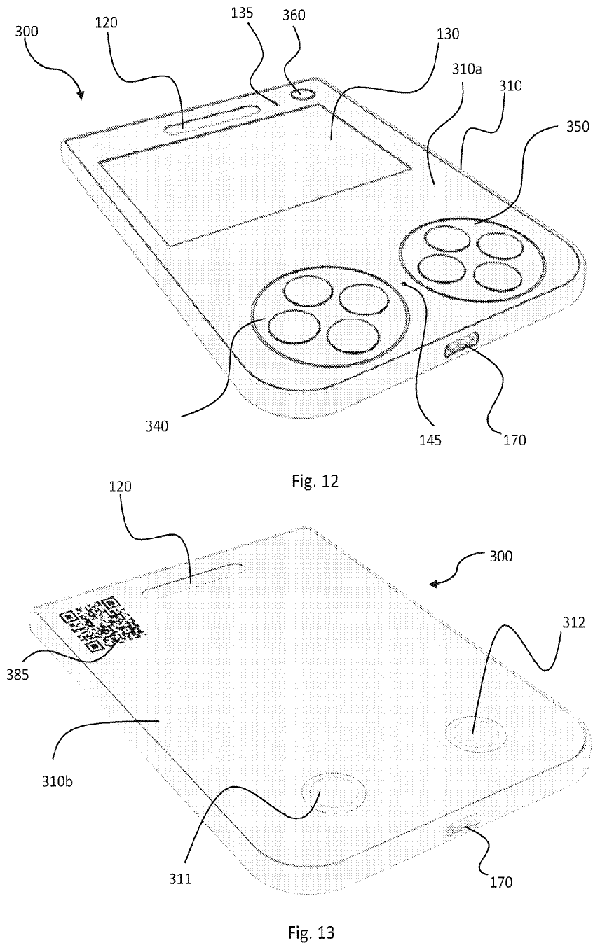

FIGS. 12 and 13 illustrates another electronic device 300 according to an aspect of the present invention. The electronic device 300 is using an injection molded polymer body 310 with silicone rubber membrane front panel 310a including a first keypad region 340 and a second keypad region 350 bonded to the front surface 310a. The rear surface 310b of the electronic device 300 has first rear button 311 and the second rear button 312. In electronic device 300, the power button 360 is positioned in the top right corner of the electronic device 300.

The electronic devices 100 and 300 have a QR code printed image, such as the printed image 385 on electronic device 300, functioning as a visual indicator, that is unique to the electronic device to which it is attached, or to each software on the electronic device, that the user can scan to activate the game stored on the electronic device, or download the game from an external device.

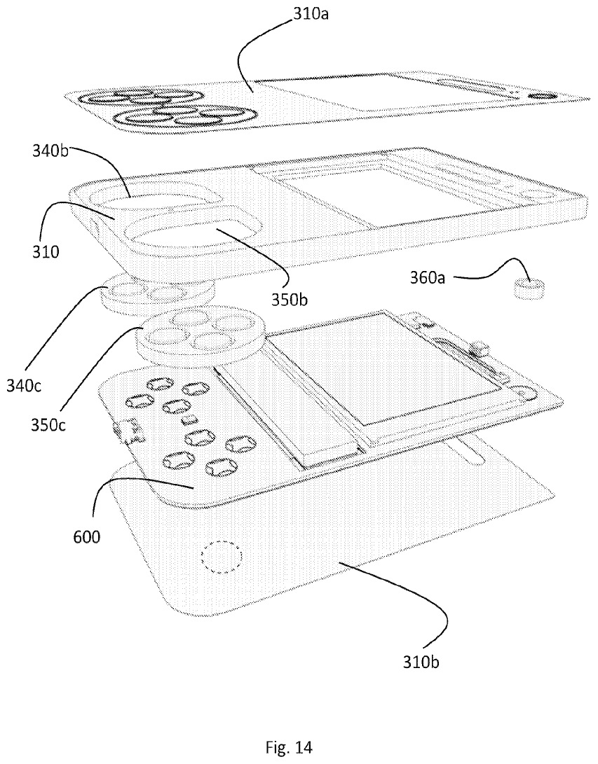

FIG. 14 illustrates an exploded view of an electronic device 300 according to an aspect of the present invention. The electronic device 300 is formed of the front membrane panel 310a that is bonded to the front of the chassis 310. The electronic device 300 has rear surface which is formed of a rear membrane panel 310b. The chassis 310 is the structure to which the front membrane panel 310a and the rear membrane plan 310b are bonded and the PCB 600 is fitted. The chassis comprise a first keypad opening 340b and a second keypad opening 350b for housing the first and second keypad portions 340, 350, respectively.

The electronic device 300 also has a first flexible actuator 340c and a second flexible actuator 350c which sit above snap dome switch buttons on the PCB 600. The electronic device 300 also includes a third flexible actuator 360a for the power button 360, which sits above the power-on snap dome switch. In some examples, the electronic device may be formed using IME (In-Mold Electronics) whereby the tracks of the electronics circuit are embedded within the polymer housing thus eliminating the need for a separate PCB. Additionally extra solid state controls can be embedded within the housing as part of the same injection molding manufacturing process e.g. capacitive touch sliders for volume control and brightness control etc.

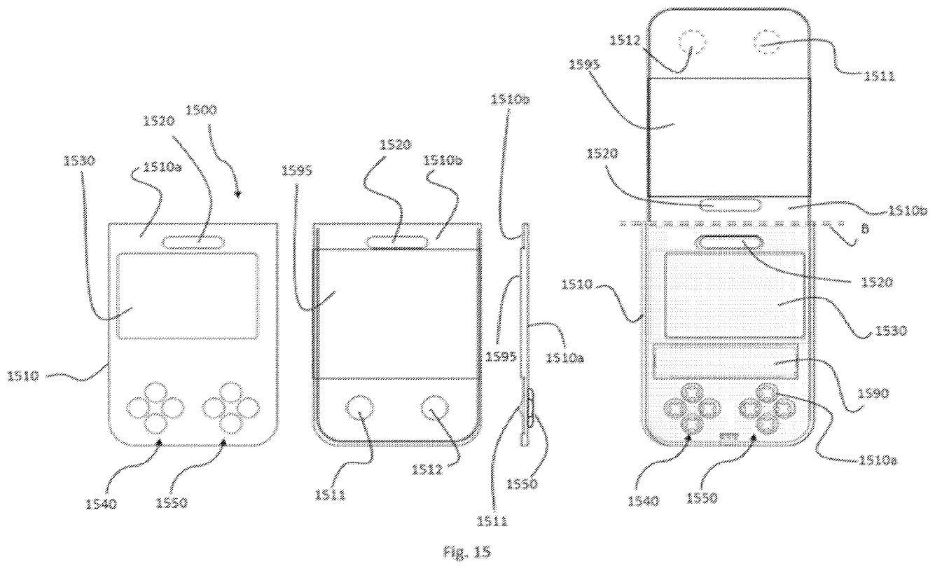

FIG. 15 illustrates an electronic device 1500 according to an aspect of the present invention. The electronic device 1500 has a clamshell construction meaning that the front surface 1510a and the rear surface 1510b are formed of a single piece.

FIG. 15 illustrates an electronic device 1500 according to an aspect of the present invention. The electronic device 1500 comprises a casing 1510 with a front surface 1510a and a rear surface 1510b. The front surface 1510a has a slot 1520, a display screen 1530, a first cluster of buttons 1540 and a second cluster of buttons 1550. The rear surface 1510b has a first rear button 1511 and a second rear button 1512. The rear surface 1510b also comprises a protrusion 1595 which is the portion of the casing 1510 surrounding the battery 1590 and the display screen 1530. In this way, the electronic device 1500 is thicker at the protrusion 1595 than at other parts of the electronic device. The casing 1510 is made of vacuum formed polymer or pulp but could also be made from injection moulded polypropylene, or a number of these materials. Other types of materials for forming the casing will be envisaged. A living hinge may connect the front surface 1510a and the rear surface 1510b, which may be formed of any of the materials listed above. The first and second diagrams show the front and rear views respectively.

From the side view, shown in the third diagram, the protrusions from the front surface 1510a include the second cluster of buttons 1550 and the protrusions from the rear surface 1510b include the first rear button 1511 and a battery 1590.

The fourth diagram shows the open plan interior view of the electronic device 1500. The components of the electronic device 1500 are housed within the clamshell construction of the electronic device 1500. The electronic device 1500 includes a living hinge along line B.

An alternative to a clamshell casing would be a casing made from two mating half pieces (without a living hinge) or instead two halves joined by an embedded flex PCB using IME (In-Mold Electronics). In this example, the front surface is formed of a first mating half and the rear surface is formed of a second mating half that fit together.

To assemble this type of electronic device, the complete motherboard assembly can be placed within the open housing and sealed by mating the front and back together as a friction fit. This construction simplifies the design further as minimal labour time is needed to assemble and no additional adhesives are needed in the production process. In addition, the product appears thinner and closer to the appearance of a traditional retail gift card.

It may be that the electronic device 1500, particularly the casing and spacers, are formed of materials such as cardboard, polypropylene, pulp and other polymers.

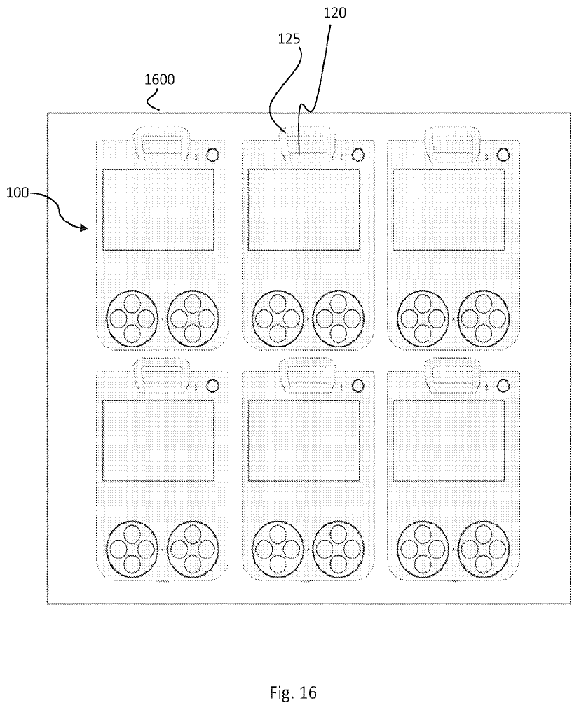

FIG. 16 illustrates an apparatus 1600 according to an embodiment of the invention. The apparatus 1600 is a display stand with six hooks 125 and an electronic device 100 hanging from each hook 125. There may be multiple electronic devices 100 hanging on each hook 125.

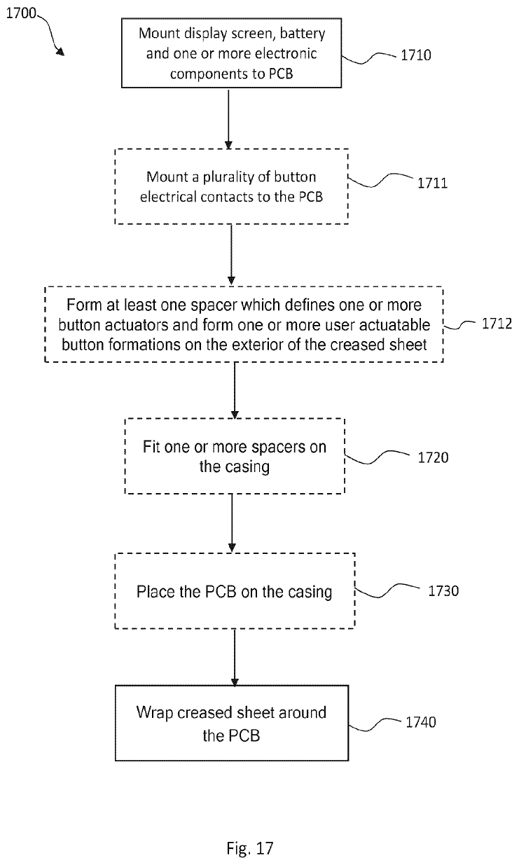

FIG. 17 illustrates a flowchart of a method 1700 according to an aspect of the present invention. The method 1700 is a method of assembling an electronic device formed of a casing 110 that is foldable around a PCB, such as electronic device 100. The method 1700 comprises forming the PCB by mounting 1710 the various components to the PCB. For example, when forming the PCB 600, the method step 1710 comprises mounting the battery 690, the electronic display unit 630, the processor 695, the speaker 135, the microphone 145, the port 170 and the plurality of dome switch buttons 640a, 650a to PCB 600. The PCB slot 620 is formed in the PCB, for example through laser cutting, which may be part of the manufacturing process of the PCB.

The method 1700 comprises wrapping 1740 the casing around the PCB to form the electronic device. This includes placing spacers, such as spacers 815, 825, between the PCB and the front surface of the casing. The casing is wrapped around the PCB using the predefined creases which dictate the correct folding to accurately assemble the electronic device.

The method 1700 comprises fitting 1720 the one or more spacers on the casing. For example, the spacers may be glued onto the casing. This method step is optional but would be performed between steps 1710 and 1740. In some methods, the spacers may be glued to the PCB first.

The method 1700 comprises placing 1730 the PCB on the casing. The PCB is placed on the casing so that the cavities in the spacer align with the position of electronic components on the PCB when the casing is folded. This method step is optional but would be performed between steps 1710 and 1740.

The method 1700 comprises mounting 1711 a plurality of button electrical contacts onto the PCB. This method step is optional but would be performed between steps 1710 and 1740. This method step 1711 involves typical electronic circuit fabrication techniques including soldering and etching.

The method 1700 comprises forming 1712 at least one spacer with the actuator portions which define one or more button actuators and forming one or more user actuatable button formations on the exterior of the casing 110 before it is folded. This method step is optional but would be performed between steps 1710 and 1740. This method step 1712 depends on the material of the casing 110. In the case of carboard casing such as that in electronic device 100, forming the one or more user actuatable button formations comprises embossing, engraving or die cutting. The button electrical contacts, the one or more button actuators and the user actuatable portions align with one another when the casing is folded.

The method may also comprise forming a metal layer on the PCB, for example by etching, which may be part of the manufacturing process of the PCB.

The resulting products do not require further individual wrapping but can be packaged in bulk, distributed and then loaded in bulk onto looped hook display stands.

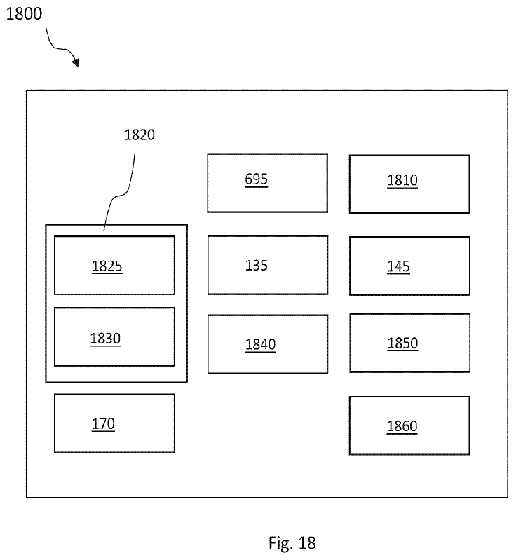

FIG. 18 illustrates a schematic of an electronic circuit 1800 of an electronic device according to an aspect of the present invention. The electronic circuit 1800 typically includes a processor, such as the processor 695 and a memory 1810. The electronic circuit 1800 also typically includes a system on a chip device 1820 which comprises a processor 1825 and a memory 1830. The electronic circuit 1800 also typically comprises the microphone 145, the speaker 135 and the port 170 for electrical connection to an external device. The electronic circuit 180 typically comprises an interface circuit 1840, a power supply circuit 1850 and a wireless communications transceiver circuit 1860. The components of the electronic circuit 1800 may communicate with one another and/or devices external to the electronic circuit 1800. Metal tracks may be formed on the PCB which are not connected to any of the components or used for example as ground tracks rather than to conduct signals.

Typically, it may be that the electronic circuit comprises a communication module, e.g. a wireless communication module which communicates with external devices using a two-way wireless communication connection. This may allow users to communicate without the need for a mobile or Wi-Fi data connection using their respective electronic devices. The two-way wireless communication connection may be Bluetooth, for example.

It may be that the planar device is sized to suit a standardized postal service. For example, it may be that planar device has a maximum length of 240 mm, a maximum width of 165 mm with thickness of up to 5 mm. In one example, it may be that the planar device has a width of 88.5 mm, a height of 128 mm and a thickness of 4 mm.

Although the embodiments described all have a front surface, with an electronic display screen thereon, in some embodiments the electronic device does not have an electronic display screen. It may be that the planar device communicates with an external device, such as a television or speaker to output information to a user.

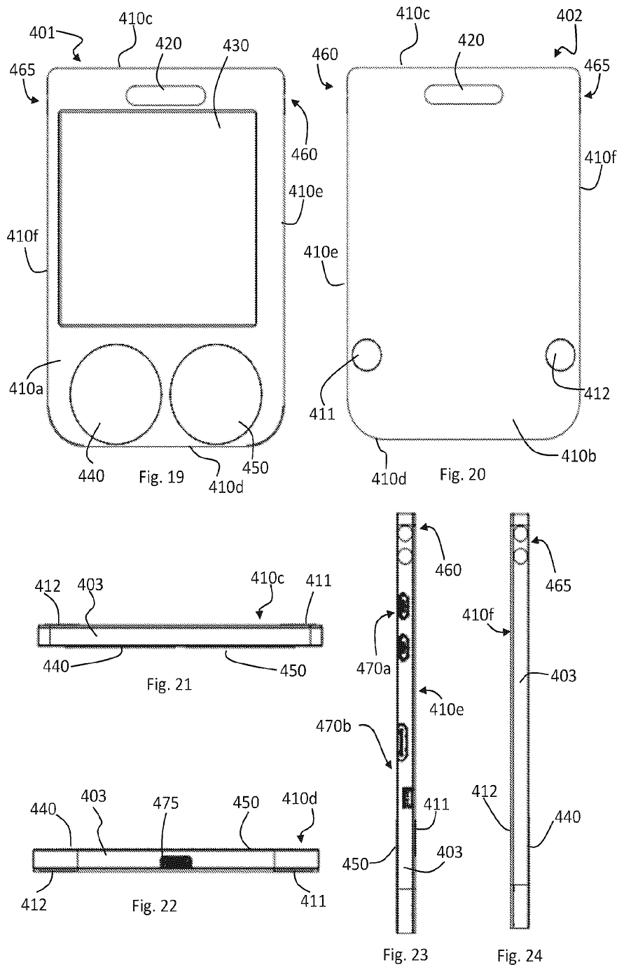

FIGS. 19 to and 26 illustrate an electronic device 400 according to a further example of the present invention. The electronic device 400 is a handheld games console. The electronic device is formed of a casing made up of three layers 401, 402, 403. The third layer 403 is positioned between the first layer 401 and the second layer 402. There is a slot 420 in a top portion of the electronic device 400 extending through each of the layers 401, 402, 403, such that when the layers 401, 402, 403 are assembled, the slot 420 extends through the entire thickness of the electronic device 400. The slot 420 allows the electronic device 400 to hang from a looped hook of a display stand, such as looped hook 125.

The electronic device 400 has a front surface 410a formed by an outward facing surface of the first layer 401. The electronic device 400 has a rear surface 410b formed by an outward facing surface of the second layer 402. The electronic device 400 has a top surface 410c which is formed of the top edges of the first, second and third layers 401, 402, 403. The electronic device 400 has a bottom surface 410d which is formed of the bottom edges of the first, second and third layers 401, 402, 403. The electronic device 400 has a left surface 410f which is formed of the left edges of the first, second and third layers 401, 402, 403. The electronic device 400 has a right surface 410e which is formed of the right edges of the first, second and third layers 401, 402, 403.

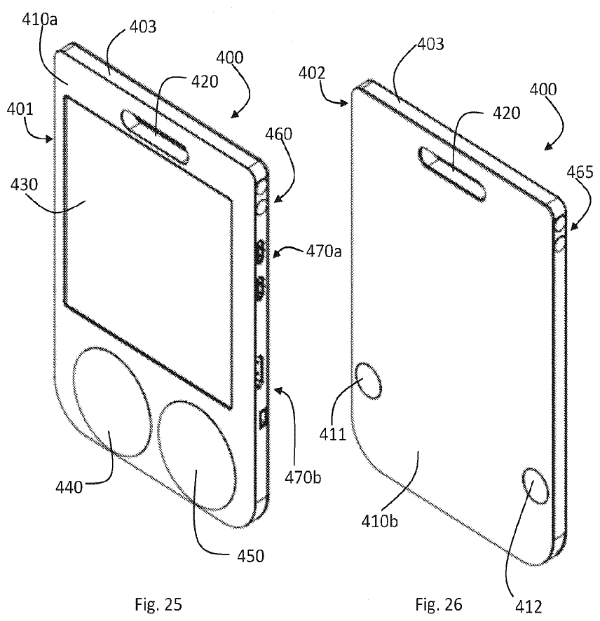

On the front surface 410a, there is a display screen 430 which displays visual images to a user of the electronic device 400 when in use. The front surface 410a also has two clusters of buttons 440, 450 which can be actuated by the user. The individual buttons are not shown on FIGS. 19 to 25, though there may be divisions or symbols to indicate button labels (e.g. arrows for “up”, “down”, “left” “right”, or letters “A”, “B”, “C”, “D”). On the rear surface 410b, there are two rear buttons 411, 412 which can be actuated by the user. On the right surface 410e, there is a first set of side buttons 460, which could include a power button and menu button. On the left surface 410f, there is a second set of side buttons 465, which could include two “function” buttons. It will be appreciated that the button types are provided by way of example only and other buttons for different commands to the electronic device will be envisaged.

On the right surface 410e, there is a first set of side ports 470a and a second set of side ports 470b. The side ports 470a, 470b enable the electronic device 400 to communicate with other electronic devices. For example, the side ports 470a, 470b include a High-Definition Multimedia Interface (HDMI) port and micro-USB ports. It will be appreciated that the port types are provided by way of example only and other ports for connection to different electronic devices will be envisaged. On the bottom surface 410d, there is a charging port 475 which enables the power storage module to be recharged when desired. It will be appreciated that the exact location of the ports 470a, 470b, 475 may vary in other examples.

The rear buttons 411, 412 do not overlap either of the first and second clusters of buttons 440, 450 (in the direction of the thickness of the device 400) so that independent actuation of each button 411, 412, 440, 450 can be achieved without unintentional actuation of another button.

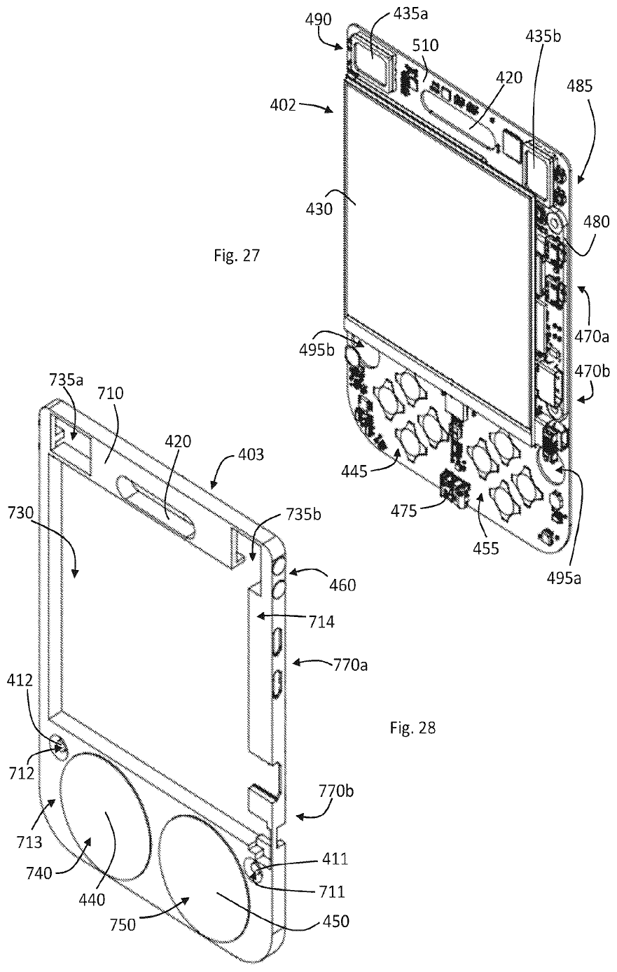

FIG. 27 illustrates the second layer 402 of the electronic device 400. The second layer 402 is a PCB 510. In particular, FIG. 27 shows an inward facing surface of the PCB 510, meaning that when the first, second and third layers 401, 402, 403 are assembled, the inward facing surface of the PCB 510 is an internal surface of the device 400. The outward facing surface of the PCB 510 is the rear surface 410b of the device 400 shown in FIGS. 20 and 26.

The PCB 510 is the motherboard of the device 400 and includes a number of electronic components soldered to the PCB 510. This includes a number of ancillary parts which are not individually labelled for simplicity. There are two speakers 435a, 435b soldered to the PCB 510, and a first set of button domes 445 and a second set of button domes 455 soldered to the PDB 510 form the electrical contacts for the clusters of buttons 440, 450. The display screen 430 is soldered to the PCB 510. Although not shown in FIG. 27, underneath the display screen 430, there is a battery connected to the PCB 510. This makes the device 400 more compact because the display screen 430 and the battery overlap one another.

As shown in FIG. 27, there are a number of ports 470a, 470b which are connected to a computing module 480 (such as a Raspberry Pi (RTM) which is computer with its own PCB). The charging port 475 is also shown on the bottom edge of the PCB 510. The computing module 480 is connected to the PCB 510 by way of a flexible circuit (not shown in FIG. 27) which is positioned beneath the computing module 480. The computing module 480 is soldered on top of the flexible circuit and the flexible circuit is soldered to the PCB 510. The display screen 430 is offset from the centre of the PCB so that the ports 470a, 470b are positioned along the right edge of the PCB 510 so that, when the device 400 is assembled, the ports 470a, 470b are accessible along the right surface 410e of the device 400.

Also along the right edge of the PCB 510, in the top right corner is the electrical contacts 485 for the first set of side buttons 460. These contacts 485 are actuated from the side, rather than from the front or back, so that they are actuated by pressing the first set of side buttons 460 on the right surface 410e of the device 400.

There are also electrical contacts 490 for the second set of side buttons 465 on the PCB 510 which are also actuated from the side, rather than from the front or back, so that they are actuated by pressing the second set of side buttons 465 on the left surface 410f of the device 400.

The PCB 510 includes two cut outs 495a, 495b. The first cut-out 495a is the space in which the first rear button 411 is provided when the device 400 is assembled. The second cut-out 495b is the space in which the second rear button 412 is provided when the device 400 is assembled.

FIG. 28 illustrates the second layer 403 of the electronic device 400. The third layer 403 is formed of a spacer 710 made of a single unitary piece. The spacer includes a display screen aperture 730 through which the display screen 430 can be seen when the device 400 is assembled. The spacer 710 has the slot 420 for the prong, which aligns with the slots on the other two layers of the device 400 when it is assembled. The spacer 710 also has two apertures 735a, 735b which, when overlaid with the second PCB 510, form a cavity for the speakers 435a, 435b respectively. The spacer 710 includes two recesses 770a, 770b for the ports 470a, 470b to be held in when the device 400 is assembled. The spacer 710 also includes the first set of side button actuators 460. Although not shown in FIG. 28, it will be appreciated that the spacer 710 includes cavities for the other ancillary components of the second PCB 510.

The varying elasticity of the spacer 710 will now be described with reference to fixed portions 713, 714, actuator portions 740, 750, which form the front button actuators 440, 450 respectively, and actuator portions 711, 712 which form the rear button actuators 411, 412 respectively. The fixed portions 713, 714 are less elastic than the actuator portions 711, 712, 740, 750. The fixed portions 713, 714 are in parts of the spacer 710 in which strength is particularly important. That is, near the edges of the spacer 710, as in fixed portion 714, and in the corners of the spacer 710, as in fixed portion 713. These fixed portions 713. 714 provide structural integrity to prevent damage to the device 400.

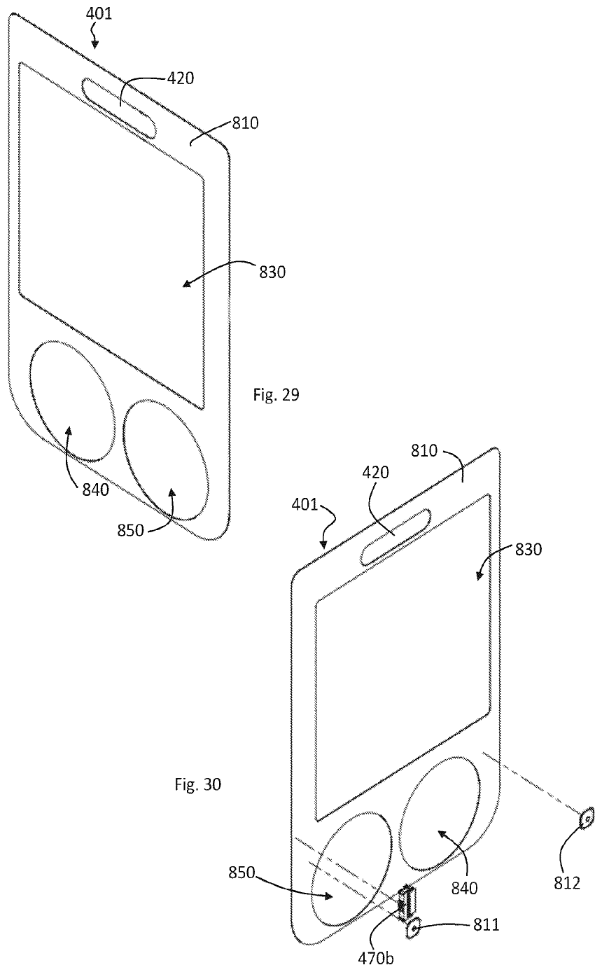

FIGS. 29 and 30 illustrate the first layer 401 of the electronic device 400. The first layer 410b is a PCB 810. In particular, FIG. 29 shows an outward facing surface of the PCB 810, meaning that when the first, second and third layers 401, 402, 403 are assembled, the outward facing surface of the PCB 810 is an external surface of the device 400. The inward facing surface of the PCB 810 is shown in FIG. 30 and is an internal surface of the device 400 when the first, second and third layers 401, 402, 403 are assembled.

The PCB 810 includes a number of electronic components soldered to the inward facing surface of the PCB 810. This includes the button domes 811, 812 for the rear buttons 411, 412. The first button dome 811 is the electrical contact for the first rear button 411. The second button dome 812 is the electrical contact for the second rear button 412. The button domes 811, 812 align with the respective cut outs 495a, 495b in the second layer 402, and the actuator portions 711, 712 of the spacer 710 when the device 400 is assembled. There is also a port 470b on the right edge of the PCB 810 so that, when the device 400 is assembled, the port 470b is accessible along the right surface 410e of the device 400.

The PCB 810 includes two apertures 840, 850 for the first cluster of buttons 440 and the second cluster of buttons 450, respectively. When the device 400 is assembled, the first set of button domes 445 and a second set of button domes 455 align with the respective cut outs 840, 850 in the first layer 401, and the actuator portions 740, 750 of the spacer 710. The PCB 810 also includes a space 830 so that the display screen 430 can be seen through the PCB 810.

It can be seen that the third layer 403 is used to provide both the front 440, 450 and rear 711, 712 buttons, whilst the cut outs 495a, 495b on the second layer 402 and the apertures 840, 850 in the first layer 401 define the periphery of the respective buttons 440, 450, 711, 712 when the device 400 is assembled.

FIG. 32 shows a schematic of part of an apparatus according to an aspect of the present invention. The PCB 810 of the first layer and the PCB 510 of the second layer communicate with one another using a connector 3310. The connector 3310 is located adjacent to the Raspberry Pi 510. The connector 3310 in this example is a flex PCB which is soldered to the PCB 510 of the second layer and plugs into a connector socket 3320 which is soldered to the PCB 810 of the first layer.

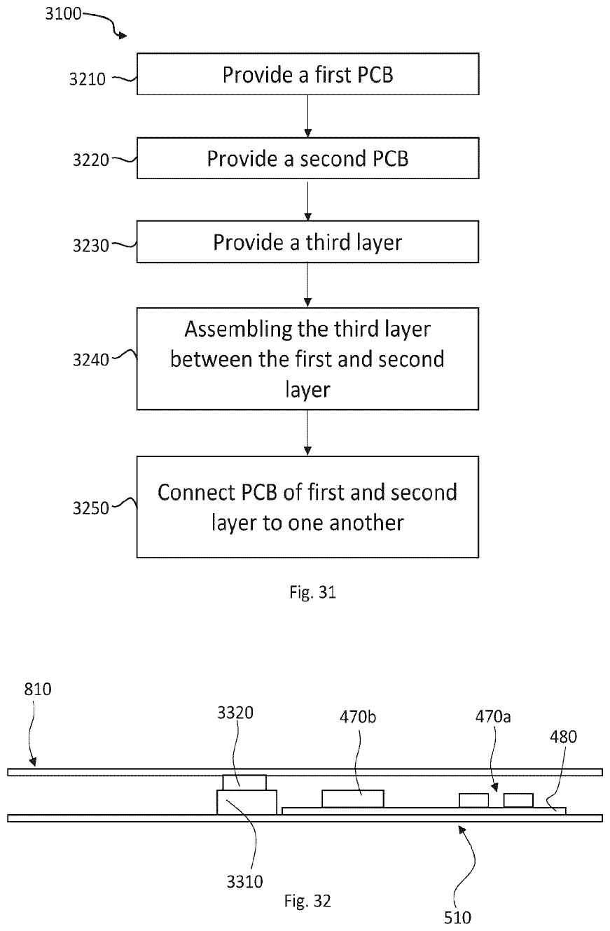

FIG. 31 illustrates a flowchart of a method 3200 according to an aspect of the present invention. The method 3200 may be used to manufacture and assemble the device 400.

In the first method step 3210, the first PCB is provided. This method step 3210 includes mounting electronic components to the first PCB, including electronic components for the rear buttons of the device. This method step 3210 also includes providing cut-outs in the first PCB for the display screen, the front buttons (e.g. the first and second clusters of buttons) and the slot for the prong.

In the next method step 3220, the second PCB provided. The second PCB functions are the mother board of the electronic device and connects to more electronic components than the first PCB. This method step 3220 includes mounting electronic components to the first PCB, including electronic components for the rear buttons of the device, the display screen and the battery. This method step 3220 also includes providing cut-outs in the second PCB for rear buttons and the slot for the prong.

In the following method step 3230, the third layer is provided. The method 3200 comprises forming 3230 the third layer by a two shot moulding process in order to provide the third layer with materials having different properties so that the elasticity varies across the third layer. The third layer is moulded into shape such that it has a slot for receiving the prong therethrough, apertures to define cavities for retaining electronic components mounted on the first and second PCBs and also an aperture for the display screen to be visible through. The third layer is moulded such that it includes button actuators on the front, rear and side surfaces of the third layer.

The next method step 3240 involves assembling the device by stacking the layers such that the third layer is between the first and second PCBs. The method may comprise attaching the PCBs and the third layer to one another by adhering each layer to another layer or by using mechanical or magnetic fasteners.

The method 3200 may comprise connecting 3250 the PCBs of the first and second layer so they can communicate with one another. This may be achieved by soldering a connector flex PCB to the PCB of the second layer and soldering a connector socket to the PCB of the first layer. The connector flex PCB comprises a plug, which plugs into the connector socket on the first PCB. This method step 3250 may be performed at whatever stage is appropriate within the method 3200.

As before, the resulting products do not require further individual wrapping but can be packaged in bulk (typically with the first layer of one device touching the second layer of an adjacent device), distributed and then loaded in bulk onto looped hook display stands.

1. A planar electronic device comprising a casing with a front surface, with an electronic display screen thereon, and an opposite back surface, a maximum thickness between the front surface and the opposite back surface of less than 1 cm, a power storage module, a processor and at least one user input device, the planar electronic device having a top portion with an aperture for receiving at least one prong therethrough.

2. A planar electronic device according to claim 1, wherein the aperture is a looped hook receiving aperture.

3. A planar electronic device according to claim 2, wherein the aperture is in the form of a slot having a width of 32±4 mm.

4. A planar electronic device according to claim 1, wherein the device comprises a first layer forming the front surface of the casing, a second layer forming the back surface of the casing and a third layer between the first and second layers, the third layer forming part of the casing.

5. A planar electronic device according to claim 4, wherein at least one of the first and second layers is a PCB.

6. A planar electronic device according to claim 5, wherein the PCB of the first layer has a thickness of 0.5 mm or less and/or the PCB of the second layer has a thickness of 1 mm or less.

7. A planar electronic device according to claim 1, wherein the elasticity of the third layer varies across at least one of its surfaces.

8. A planar device according to claim 1, wherein the planar electronic device comprises a top portion with an aperture for receiving at least one prong therethrough and wherein the aperture for receiving the at least one prong is formed by overlapping apertures in the first, second and third layers.

9. A planar electronic device according to claim 1, wherein the third layer is formed of one or more polymer materials.

10. A planar electronic device according claim 1, wherein at least 25% of at least one surface of the PCB of the first and/or second layer is metalized, optionally wherein the metallization is gold.

11. A planar electronic device according to claim 1, wherein the electronic display screen is part of an electronic display unit, the electronic display unit being rectangular and having a viewable region with an electronic driver circuitry along a side thereof, the casing comprising a display aperture being rectangular and having a centre which is offset from the longitudinal axis of the casing.

12. A planar electronic device according to claim 1, comprising one or more spacers within the casing which, with the first and/or second layers, define one or more cavities which retain one or more electronic circuit components.

13. A planar electronic claim 1, wherein the third layer comprises the one or more spacers and one or more apertures such that the one or more spacers and the one or more apertures of the third layer thereby define one or more said cavities.

14. A planar electronic device according to claim 13, wherein the one or more electronic circuit components comprise a speaker, and the PCB of the first or second layer and a surrounding spacer enclose the speaker, thereby forming a sound baffle.

15. A planar electronic device according to claim 1, having a top portion with an aperture for receiving at least one prong therethrough and comprising a said cavity retaining one or more electronic circuit components located on the left side, and/or the right side, of the aperture for receiving the at least one prong.

16. A planar electronic device according to claim 1, the third layer comprising a spacer comprising at least one fixed portion and at least one actuator portion which defines one or more button actuators, the at least one fixed portion having a lower elasticity than the one or more button actuators.

17. A planar electronic device according to claim 16, wherein the one or more button actuators comprise at least one, and typically at least two, clusters of buttons.

18. A planar electronic device according to claim 1, wherein at least one of the first and second layer comprise one or more apertures, wherein at least one of the button actuators of the spacer of the third layer is exposed through one of the one or more apertures.

19. A planar electronic device according to claim 18, wherein at least one of the button actuators extends through the respective aperture in the first or second layer and protrudes beyond the front or back surface of the casing.

20. A planar electronic device according to claim 1, comprising one or more clusters of buttons on the front surface and one or more buttons on the rear surface.

21. A planar electronic device according to claim 1, comprising one or more side button actuators on a side surface of the casing and/or one or more input/output ports on a side surface of the casing of the device.

22. A planar electronic device according to claim 1, or any claim dependent thereon, wherein third layer comprises the one or more side button actuators and the PCB of the first or second layer comprises an electronic component for each of the side button actuators.

23. A planar electronic device according to claim 22, wherein at least one of the one or more side button actuators protrudes beyond the edge of the front or back surface of the casing.

24. A planar electronic device according to claim 1, wherein the one or more input/output ports are connected to the PCB of the first or second layer, and the third layer comprises one or more recesses, each recess configured to accommodate at least one of the one or more input/output ports therein.

25. A planar electronic device according to claim 1, wherein the PCB of the first and/or second layer comprises a first region in which no electrical contact is present and no solder mask is applied, optionally wherein the first region overlaps a light emitting device within the casing.

26. A planar electronic device according to claim 1, having a unique visual indicator visible on the casing, which unique visual indicator is usable to download one or more software applications to the planar electronic device or to activate one or more software application prerecorded on the planar electronic device.

27. A planar electronic device according to claim 1, wherein both the first layer and the second layer comprise a PCB and communicate with one another using a connector.

28. An apparatus comprising a display stand having one or more looped hooks protruding therefrom and on at least one looped hook, a plurality of planar electronic devices according to claim 1, hanging therefrom by virtue of the looped hook passing through their aperture for receiving the at least one prong.

29. A method of construction of a planar electronic device according claim 1, the method comprising:
mounting one or more electronic components to a first PCB;
mounting the display screen, a battery and one or more further electronic components to a second PCB comprising a display screen aperture; and
providing a third layer between the first and second PCBs such that the display screen is visible through the display screen aperture and the first PCB forms the front surface of the casing of the planar electronic device and the second PCB forms the back surface of the casing of the planar electronic device.

30. A method according to claim 29, comprising forming one or more spacers in the third layer, the one or more spacers defining one or more cavities within which one or more electronic components attached to the first and/or second PCB are located.

31. A method according to claim 1, further comprising mounting a plurality of button electrical contacts to the first and/or second PCB and forming at least one spacer in the third layer which comprises at least one fixed portion and at least one actuator portion which defines one or more button actuators and providing each of the one or more button actuators in a corresponding aperture on the first or second PCB, such that the one or more button actuators overlay the button electrical contacts in the planar electronic device.

32. A method according claim 1, comprising forming the third layer from a first material and a second material, the first material having a lower elasticity than the second material.
